(19) United States
(12) Patent Application Publication
(10) Pub. No.: US 2023/0159724 A1
(43) Pub. Date: May 25, 2023

(54) Elastomer Compositions with Carbon Nanostructure Filler

(71) Applicant: Beyond Lotus LLC, Wilmington, DE (US)

(72) Inventors: Limeng Chen, Arlington, MA (US); Jiaxi Li, Nashua, NH (US); Agathagelos Kyrlidis, Cambridge, MA (US); Dhaval A. Doshi, Lexington, MA (US); Ping Zhang, Westord, MA (US)

(21) Appl. No.: 17/919,900

(22) PCT Filed: Apr. 16, 2021
(86) PCT No.: PCT/US2021/027814

§ 371 Date: Oct. 19, 2022

Related U.S. Application Data
(60) Provisional application No. 63/012,328, filed on Apr. 20, 2020.
(60) Provisional application No. 63/123,366, filed on Dec. 9, 2020.
(60) Provisional application No. 63/123,393, filed on Dec. 9, 2020.

(51) Int. Cl. C08K 3/04; C09C 3/10; B60C 1/00; C08K 3/36; C09C 3/06

(52) U.S. Cl. CPC C08K 3/041; C09C 3/10; B60C 1/0016; B60C 1/0025; C08K 3/36; C09C 3/063; C08K 2201/011

(57) ABSTRACT

Elastomeric compositions are described that include at least one filler that are carbon nanostructures or fragments thereof. Methods to prepare elastomeric compositions are further described. Loadings of the carbon nanostructures can be from about 0.1 phr to about 50 phr or a volume fraction of from about 0.1 vol % to about 20 vol %.

### FIELD OF THE INVENTION

Disclosed herein are elastomer compositions, which can also be considered composites. Also disclosed are elastomer compositions that contain a filler referred to herein as carbon nanostructures (CNS) and articles or parts thereof containing the elastomer compositions. Methods of making the elastomer compositions and/or articles thereof are a further aspect of the present invention.

### BACKGROUND

Numerous products of commercial significance are formed of elastomeric compositions wherein particulate reinforcing material is dispersed in any of various synthetic elastomers, natural rubber, or elastomer blends. Carbon black and silica, for example, are widely used as reinforcing agents in natural rubber and other elastomers. It is common to produce a masterbatch, that is, a premixture of reinforcing material, elastomer, and various optional additives, such as extender oil. Numerous products of commercial significance are formed of such elastomeric compositions. Such products include, for example, vehicle tires wherein different elastomeric compositions may be used for the tread portion, sidewalls, wire skim and carcass. Other products include, for example, engine mount bushings, conveyor belts, windshield wipers, seals, liners, wheels, bumpers, and the like.

There is always an effort to have ways to improve upon one or more mechanical and/or electrical properties in an elastomeric composition, sometimes with minimal filler additions. Generally, fillers such as carbon black and silica, commonly used fillers in elastomeric compositions, generally require large amounts of filler additions to achieve one or more desirable mechanical and/or electrical properties. It would be beneficial to have the ability to use less filler amounts and yet achieve comparable if not greater mechanical and/or electrical property results.

### SUMMARY

One aspect disclosed herein is to provide elastomeric compositions that can utilize lower amounts of filler and yet achieve at least one desirable mechanical and/or electrical property.

Another aspect disclosed herein is to provide elastomeric compositions that utilize one or more fillers that significantly increase one or more elastomer properties using the same or lower amounts than reinforcing carbon black (e.g., a furnace black).

Accordingly, another aspect relates to an elastomeric composition. The elastomeric composition includes at least one elastomer and includes at least one primary filler that is selected from at least one of carbon nanostructures, fragments of carbon nanostructures, fractured multiwall carbon nanotubes, and combinations thereof. The elastomeric composition optionally includes at least one secondary filler. The primary filler(s) can be present in an amount of from 0.1 phr to about 50 phr (or more) (e.g., filler loading level) or a volume fraction amount of from about 0.1 vol % to about 20 vol %. The carbon nanostructures or fragments of carbon nanostructures include a plurality of multiwall carbon nanotubes that are crosslinked in a polymeric structure by being branched, interdigitated, entangled and/or sharing common walls. Further, the fractured multiwall carbon nanotubes are derived from the carbon nanostructures and are branched and share common walls with one another.

Another aspect relates to an article of manufacture that includes or is made from or formed from (at least in part) the elastomeric composition of present invention.

Other aspects relates to methods for preparing the elastomeric composition disclosed herein. A method can involve or include the step of combining at least one elastomer and at least one primary filler and optionally at least one secondary filler to form the elastomeric composition. The step of combining can optionally involve or include forming a masterbatch by combining the at least one elastomer and the at least one primary filler, and combining the masterbatch with at least one secondary filler. Alternatively, the step of combining can involve or include providing a continuous flow under pressure of at least a first fluid that includes the at least one primary filler, and a continuous flow of at least a second fluid that includes an elastomer latex; and combining the first fluid flow and the second fluid flow with a sufficiently energetic impact to distribute the at least one primary filler within the elastomer latex to obtain a flow of a solid filler-containing continuous rubber phase or semi-solid filler-containing continuous rubber phase. The solid filler-containing continuous rubber phase or semi-solid filler-containing continuous rubber phase can then be subjected to one or more dewatering steps and one or more compounding steps.

As another option, the method of forming the elastomeric composition can involve, prior to the combining step, a step of providing a continuous flow under pressure of at least a first fluid with a filler, and a continuous flow of at least a second fluid comprising elastomer latex; and combining the first fluid flow and the second fluid flow with a sufficiently energetic impact to distribute the filler within the elastomer latex to obtain a flow of a solid filler-containing continuous rubber phase or semi-solid filler-containing continuous rubber phase. Then, upon forming of the solid filler-containing continuous rubber phase or semi-solid filler-containing continuous rubber phase, conducting a dewatering step of the solid filler-containing continuous rubber phase or semi-solid filler-containing continuous rubber phase to obtain a dewatered extrudate. Then the combining step can involve combining at least one dewatered extrudate and the at least one primary filler and optionally at least one secondary filler in a mixer to form said elastomeric composition. The mixer can be a continuous mixer or other type of mixer. As an option, more than one mixing step can be used with the same or different mixers.

Another aspect is a method of preparing or forming a composite by mixing a solid elastomer with a wet filler. The method can comprise:

(a) charging a mixer with at least a solid elastomer and a wet filler comprising at least one primary filler (and optionally at least one secondary filler) and a liquid present in an amount of at least 50% by weight based on total weight of wet filler;

(b) in one or more mixing steps, mixing the at least the solid elastomer and the wet filler to form a mixture, and removing at least a portion of the liquid from the mixture by evaporation; and

(c) discharging, from the mixer, the composite comprising the at least one primary filler dispersed in the elastomer, wherein the composite has a liquid content of no more than 20% by weight based on total weight of said composite,

wherein the at least one primary filler is selected from carbon nanostructures, fragments of carbon nanostructures, fractured multiwall carbon nanotubes, and combinations thereof, wherein the carbon nanostructures or fragments of carbon nanostructures include a plurality of multiwall carbon nanotubes that are crosslinked in a polymeric structure by being branched, interdigitated, entangled and/or sharing common walls, and wherein the fractured multiwall carbon nanotubes are derived from the carbon nanostructures and are branched and share common walls with one another.

Another aspect is a method of preparing a composite, comprising:

(a) charging a mixer with at least a solid elastomer, at least one primary filler, and a wet filler comprising at least one secondary filler and a liquid present in an amount of at least 15% by weight based on total weight of wet filler;

(b) in one or more mixing steps, mixing the at least the solid elastomer and the wet filler to form a mixture, and removing at least a portion of the liquid from the mixture by evaporation; and

(c) discharging, from the mixer, the composite comprising the at least one primary and secondary filler dispersed in the elastomer, wherein the composite has a liquid content of no more than 10% by weight based on total weight of said composite,

wherein the at least one primary filler is selected from carbon nanostructures, fragments of carbon nanostructures, fractured multiwall carbon nanotubes, and combinations thereof, wherein the carbon nanostructures or fragments of carbon nanostructures include a plurality of multiwall carbon nanotubes that are crosslinked in a polymeric structure by being branched, interdigitated, entangled and/or sharing common walls, and wherein the fractured multiwall carbon nanotubes are derived from the carbon nanostructures and are branched and share common walls with one another.

Another aspect is a method of preparing a vulcanizate, comprising curing any of the composites disclosed herein, or prepared by any of the methods disclosed herein, in the presence of at least one curing agent to form the vulcanizate. Other aspects are composites, vulcanizate and articles formed therefrom.

As used herein, the term “carbon nanostructure” or “CNS” refers to a plurality of carbon nanotubes (CNTs), multiwall (also known as multi-walled) carbon nanotubes (MWCNTs), in many cases, that can exist as a polymeric structure by being interdigitated, branched, crosslinked, and/or sharing common walls with one another. Thus, CNSs can be considered to have CNTs, such as, for instance, MWCNTs, as a base monomer unit of their polymeric structure. Typically, CNSs are grown on a substrate (e.g., a fiber material) under CNS growth conditions. In such cases, at least a portion of the CNTs in the CNSs can be aligned substantially parallel to one another, much like the parallel CNT alignment seen in conventional carbon nanotube forests.

The CNSs can be provided as loose particles (e.g., in the form of pellets, flakes, granules, etc.) or dispersed in a suitable dispersant or matrix (e.g., masterbatch).

It is to be understood that both the foregoing general description and the following detailed description are exemplary and explanatory only and are intended to provide a further explanation of the present invention, as claimed.

The above and other features of the invention including various details of construction and combinations of parts, and other advantages, will now be more particularly described with reference to the accompanying drawings and pointed out in the claims. It will be understood that the particular aspects embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIGS. 1A and 1B are diagrams illustrating differences between a Y-shaped MWCNT, not in or derived from a carbon nanostructure (FIG. 2A), and a branched MWCNT (FIG. 2B) in a carbon nanostructure;

FIGS. 2A and 2B are TEM images showing features characterizing multiwall carbon nanotubes found in carbon nanostructures;

FIGS. 2C and 2D are SEM images of carbon nanostructures showing the presence of multiple branches;

FIG. 3A is an illustrative depiction of a carbon nanostructure flake material after isolation of the carbon nanostructure from a growth substrate;

FIG. 3B is a SEM image of an illustrative carbon nanostructure obtained as a flake material;

FIG. 4 is a SEM image showing CNS dispersed in an elastomer (here, dispersed in fluoroelastomer (FKM) (5 PHR of CNS) following the method described in Example 1. As shown in the image, the structure of CNS can be seen with some branching.

### DETAILED DESCRIPTION

The detailed description now will be disclosed more fully hereinafter with reference to the accompanying drawings, in which illustrative embodiments are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Generally, disclosed herein are elastomeric compositions or elastomer composites that, for instance, can be used to form elastomeric and/or polymeric articles, as further described herein. The polymeric article(s) can be thermoplastic or thermoset. The article(s) can be vulcanized.

As used herein, a “elastomeric composition” or “elastomer composite” means a masterbatch (a premixture of reinforcing material), elastomer, and various optional additives, such as extender oil) of coherent rubber comprising an amount (e.g., about 0.1 phr to about 50 phr or other amounts disclosed herein) such as a reinforcing amount of dispersed primary filler. The elastomeric composition or elastomer composite can contain optional, further components such as acid, salt, antioxidant, antidegradants, coupling agents, minor amounts (e.g., 10 wt. % or less of total particulates) of other particulates, processing aids, and/or extender oil, or any combinations thereof. Other optional components can include one or more resins, curative(s) such as sulfur, accelerators, and/or retarders.

Also disclosed are articles made from one or more elastomeric compositions or polymeric compositions disclosed herein, such as a tire or part thereof, and other elastomeric and/or polymeric articles.

Also disclosed herein, in part, are methods of preparing or forming a composite by mixing a solid elastomer with a wet filler. Also disclosed herein, in part, are composites, vulcanizates, and articles formed therefrom.

In more detail, the elastomeric composition includes at least one elastomer and includes at least one primary filler that is carbon nanostructures, fragments of carbon nanostructures, or fractured multiwall carbon nanotubes, or any combinations thereof. The elastomeric composition optionally includes at least one secondary filler. The primary filler(s) is present in an amount of from 0.1 phr to about 50 phr (or more). The amount of primary filler that can be present in the elastomeric composition can be an amount based on a volume fraction of the primary filler. This amount can be from about 0.1 vol % to about 20 vol % (volume fraction amount).

The carbon nanostructures (CNS) or fragments of carbon nanostructures include a plurality of multiwall carbon nanotubes that are crosslinked in a polymeric structure by being branched, interdigitated, entangled and/or sharing common walls. Further, the fractured multiwall carbon nanotubes are derived from carbon nanostructures and are branched and share common walls with one another.

With respect to the at least one primary filler, the term “carbon nanostructures” (CNSs, singular CNS) refers herein to a plurality of carbon nanotubes (CNTs) that are crosslinked in a polymeric structure by being branched, e.g., in a dendrimeric fashion, interdigitated, entangled and/or sharing common walls with one another. In using the CNSs or during the formation of the elastomeric composition, CNS fragments and/or fractured CNTs can form or be present. Fragments of CNSs are derived from CNSs and, like the larger CNS, include a plurality of CNTs that are crosslinked in a polymeric structure by being branched, interdigitated, entangled and/or sharing common walls. Fractured CNTs are derived from CNSs, are branched and share common walls with one another.

Highly entangled CNSs are macroscopic in size and can be considered to have a carbon nanotube (CNT) as a base monomer unit of its polymeric structure. For many CNTs in the CNS structure, at least a portion of a CNT sidewall is shared with another CNT. While it is generally understood that every carbon nanotube in the CNS need not necessarily be branched, crosslinked, or share common walls with other CNTs, at least a portion of the CNTs in the carbon nanostructure can be interdigitated with one another and/or with branched, crosslinked, or common-wall carbon nanotubes in the remainder of the carbon nanostructure.

As known in the art, carbon nanotubes (CNT or CNTs plural) are carbonaceous materials that include at least one sheet of sp²-hybridized carbon atoms bonded to each other to form a honey-comb lattice that forms a cylindrical or tubular structure. The carbon nanotubes can be single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWNTs.

The CNSs can have one or more of the following characteristics (e.g., two, three or all four of the characteristics), which are further described herein:

at least one of the multiwall carbon nanotubes has a length equal to or greater than 2 μm, as determined by scanning electron microscopy (SEM), and/or

at least one of the multiwall carbon nanotubes has a length to diameter aspect ratio within a range of from 10 to 1000, and/or

there are at least two branches along a 2-micrometer length of at least one of the multiwall carbon nanotube, as determined by SEM, and/or

at least one multiwall carbon nanotube exhibits an asymmetry in the number of walls observed in the area after a branching point relative to the area prior to the branching point, and/or

no catalyst particle is present at or near branching points, as determined by TEM.

In many of the CNSs disclosed herein, the CNTs are MWCNTs, having, for instance, at least 2 coaxial carbon nanotubes. The number of walls present, as determined, for example, by transmission electron microscopy (TEM), at a magnification sufficient for analyzing the number of walls in a particular case, can be within the range of from 2 to 30 or so, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28; 4 to 28; 6 to 28; 8 to 28; 10 to 28; 12 to 28; 14 to 28; 16 to 28; 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26; or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20; 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4-6; or 2 to 4.

Since a CNS is a polymeric, highly branched and crosslinked network of CNTs, at least some of the chemistry observed with individualized CNTs may also be carried out on the CNS.

However, as used herein, the term “CNS” is not a synonym for individualized, un-entangled structures such as “monomeric” fullerenes (the term “fullerene” broadly referring to an allotrope of carbon in the form of a hollow sphere, ellipsoid, tube, e.g., a carbon nanotube, and other shapes). In fact, many embodiments disclosed herein highlight differences and advantages observed or anticipated with the use of CNSs as opposed to the use of their CNTs building blocks. Without wishing to be held to a particular interpretation, it is believed that the combination of branching, crosslinking, and wall sharing among the carbon nanotubes in a CNS reduces or minimizes the van der Waals forces that are often problematic when using individual carbon nanotubes in a similar manner.

In addition, or alternatively to performance attributes, CNTs that are part of or are derived from a CNS can be characterized by a number of features, at least some of which can be relied upon to distinguish them from other nanomaterials, such as, for instance, ordinary CNTs (namely CNTs that are not derived from CNSs and can be provided as individualized, pristine or fresh CNTs).

In many cases, a CNT present in or derived from a CNS has a typical diameter of 100 nanometers (nm) or less, such as, for example, within the range of from about 5 to about 100 nm, e.g., within the range of from about 5 to about 75, from about 5 to about 50, from about 5 to about 30, from about 5 to about 20, from about 5 to about 10, from about 10 to about 100, from about 10 to about 75, from about 10 to about 50, from about 10 to about 30, or from about 10 to about 20 nm.

In specific embodiments, at least one of the CNTs, derived from an CNS, has a length that is equal to or greater than 2 μm, as determined by SEM. For example, at least one of the CNTs will have a length within a range of from 2 to 2.25 μm; from 2 to 2.5 μm; from 2 to 2.75 μm; from 2 to 3.0 μm; from 2 to 3.5 μm; from 2 to 4.0 μm; or from 2.25 to 2.5 μm; from 2.25 to 2.75 μm; from 2.25 to 3 μm; from 2.25 to 3.5 μm; from 2.25 to 4 μm; or from 2.5 to 2.75 μm; from 2.5 to 3 μm; from 2.5 to 3.5 μm; from 2.5 to 4 μm; or from 3 to 3.5 μm; from 3 to 4 μm; of from 3.5 to 4 μm or higher.

In some embodiments, more than one, e.g., a portion such as a fraction of at least about 0.1%, at least about 1%, at least about 10%, at least about 15%, at least about 20%, at least about 25%, at least about 30%, at least about 35%, at least about 40%, at least about 45%, at least about 50% or even more than one half, of the CNTs, as determined by SEM, can have a length greater than 2 am, e.g., within one or more of the ranges specified above.

In some embodiments, more than one, e.g., a portion such as a fraction of at least about 0.1%, at least about 1%, at least about 10%, at least about 15%, at least about 20%, at least about 25%, at least about 30%, at least about 35%, at least about 40%, at least about 45%, at least about 50% or even more than one half, of the CNTs, as determined by SEM, can have a length to diameter aspect ratio within a range of from 10 to 1000 (e.g., within one or more of the ranges specified above).

In some embodiments, more than one, e.g., a portion such as a fraction of at least about 0.1%, at least about 1%, at least about 10%, at least about 15%, at least about 20%, at least about 25%, at least about 30%, at least about 35%, at least about 40%, at least about 45%, at least about 50% or even more than one half, of the CNTs, as determined by SEM, can have a asymmetry in the number of walls observed in the area after a branching point relative to the area prior to the branching point.

The morphology of CNTs present in a CNS, in a fragment of a CNS or in a fractured CNT derived from a CNS will often be characterized by a high aspect ratio, with lengths typically more than 100 times the diameter, and in certain cases much higher. For instance, in a CNS (or CNS fragment), the length to diameter aspect ratio of CNTs can be within a range of from about 10 to about 1000, or from about 20 to about 1000, or from about 30 to about 1000, or from about 40 to about 1000, or from about 50 to about 1000, or from about 60 to about 1000, or from about 70 to about 1000, or from about 80 to about 1000, or from about 90 to about 1000, or from about 100 to 1000, or from about 120 to about 1000, or from about 140 to about 1000, or from about 160 to about 1000, or from about 180 to about 1000, or from about 200 to about 1000, such as, for instance, from 10 to 200, from 20 to 200, from 30 to 200, from 40 to 200, from 50 to 200, from 60 to 200, from 70 to 200, from 80 to 200, from 90 to 200, from 100 to 200, from 10 to 100, from 20 to 100, from 30 to 100, from 40 to 100, from 50 to 100, from 200 to 300; from 200 to 400; from 200 to 500; from 200 to 600; from 200 to 700; from 200 to 800; from 200 to 900; or from 300 to 400; from 300 to 500; from 300 to 600; from 300 to 700; from 300 to 800; from 300 to 900; from 300 to 1000; or from 400 to 500; from 400 to 600; from 400 to 700; from 400 to 800; from 400 to 900; from 400 to 1000; or from 500 to 600; from 500 to 700; from 500 to 800; from 500 to 900; from 500 to 1000; or from 600 to 700; from 600 to 800; from 600 to 900; from 600 to 1000; from 700 to 800; from 700 to 900; from 700 to 1000; or from 800 to 900; from 800 to 1000; or from 900 to 1000.

It has been found that in CNSs, as well as in structures derived from CNSs (e.g., in fragments of CNSs or in fractured CNTs), at least one of the CNTs is characterized by a certain “branch density”. As used herein, the term “branch” refers to a feature in which a single carbon nanotube diverges into multiple (two or more), connected multiwall carbon nanotubes. One embodiment has a branch density according to which, along a two-micrometer length of the carbon nanostructure, there are at least two branches, as determined by SEM. Three or more branches also can occur.

Further features (detected using TEM or SEM, for example) can be used to characterize the type of branching found in CNSs relative to structures such as Y-shaped CNTs that are not derived from CNSs. For instance, whereas Y-shaped CNTs, have a catalyst particle at or near the area (point) of branching, such a catalyst particle is absent at or near the area of branching occurring in CNSs, fragments of CNSs or fractured CNTs.

In addition, or in the alternative, the number of walls observed at the area (point) of branching in a CNS, fragment of CNS or fractured CNTs, differ from one side of the branching (e.g., before the branching point) to the other side of this area (e.g., after or past the branching point). Such a change in the number of walls, also referred to herein as an “asymmetry” in the number of walls, is not observed with ordinary Y-shaped CNTs (where the same number of walls is observed in both the area before and the area past the branching point).

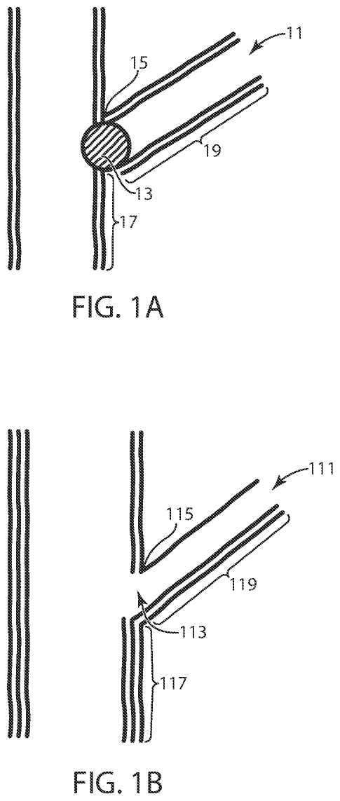

Diagrams illustrating these features are provided in FIGS. 1A and 1B. Shown in FIG. 1A, is an exemplary Y-shaped CNT 11 that is not derived from a CNS. Y-shaped CNT 11 includes catalyst particle 13 at or near branching point 15. Areas 17 and 19 are located, respectively, before and after the branching point 15. In the case of a Y-shaped CNT such as Y-shaped CNT 11, both areas 17 and 19 are characterized by the same number of walls, i.e., two walls in the drawing.

In contrast, in a CNS, a CNT building block 111, that branches at branching point 115, does not include a catalyst particle at or near this point, as seen at catalyst devoid region 113. Furthermore, the number of walls present in region 117, located before, prior (or on a first side of) branching point 115 is different from the number of walls in region 119 (which is located past, after or on the other side relative to branching point 115. In more detail, the three-walled feature found in region 117 is not carried through to region 119 (which in the diagram of FIG. 1B has only two walls), giving rise to the asymmetry mentioned above.

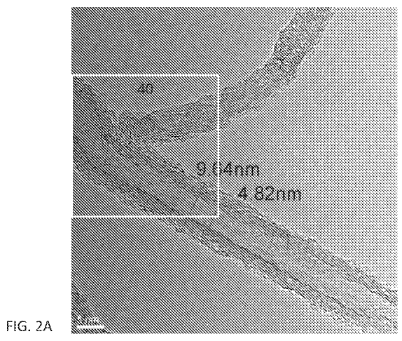

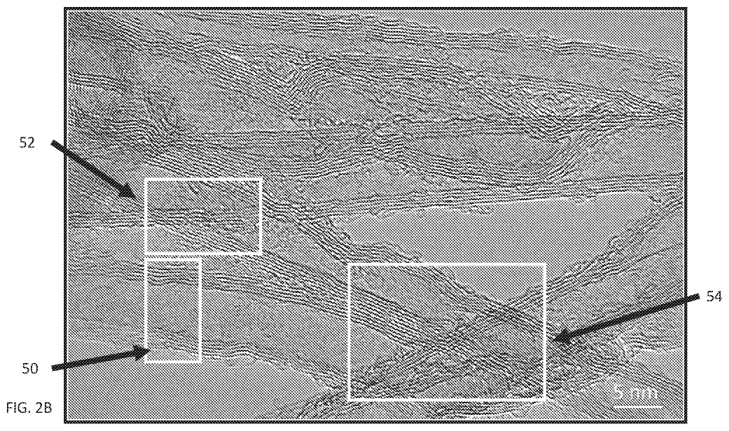

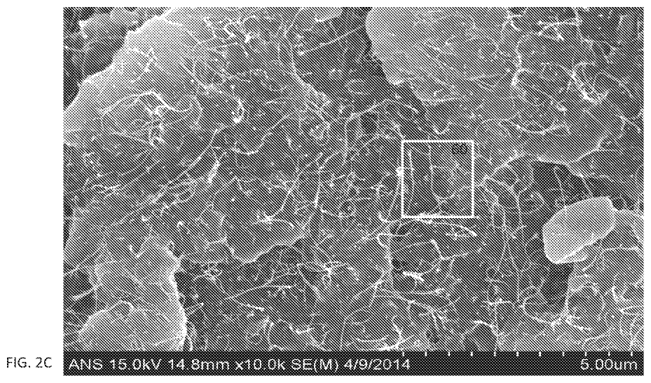

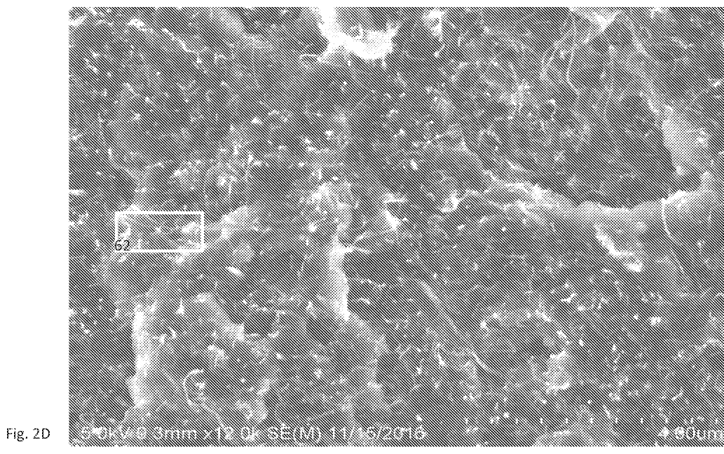

These features are highlighted in the TEM images of FIGS. 2A and 2B and SEM images of FIGS. 2C through 2D.

In more detail, the CNS branching in TEM region 40 of FIG. 2A shows the absence of any catalyst particle. In the TEM of FIG. 2B, first channel 50 and second channel 52 point to the asymmetry in the number of walls featured in branched CNSs, while arrow 54 points to a region displaying wall sharing. Multiple branches are seen in the SEM regions 60 and 62 of FIGS. 2C and 2D, respectively.

One, more, or all these attributes can be encountered in the elastomeric compositions described herein.

In some embodiments, the CNS is present as part of an entangled and/or interlinked network of CNSs. Such an interlinked network can contain bridges between CNSs.

Suitable techniques for preparing CNSs are described, for example, in U.S. Patent Application Publication No. 2014/0093728 A1, published on Apr. 3, 2014, U.S. Pat. Nos. 8,784,937B2; 9,005,755B2; 9,107,292B2; and 9,447,259B2. The entire contents of these documents are incorporated by reference herein.

As described in these documents, CNS can be grown on a suitable substrate, for example on a catalyst-treated fiber material. The product can be a fiber-containing CNS material. In some cases, the CNSs are separated from the substrate to form flakes.

As seen in US 2014/0093728A1, a carbon nanostructure obtained as a flake material (i.e., a discrete particle having finite dimensions) exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the CNS can be modulated to some degree by adjusting the carbon nanostructure growth conditions, including, for example, by changing the concentration of transition metal nanoparticle catalyst particles that are disposed on the growth substrate to initiate carbon nanotube growth.

The flakes can be further processed, e.g., by cutting or fluffing (operations that can involve mechanical ball milling, grinding, blending, etc.), chemical processes, or any combination thereof.

In some embodiments, the CNSs employed are “coated”, also referred to herein as “sized” or “encapsulated” CNSs. In a typical sizing process, the coating is applied onto the CNTs that form the CNS. The sizing process can form a partial or a complete coating that is non-covalently bonded to the CNTs and, in some cases, can act as a binder. In addition, or in the alternative, the size can be applied to already formed CNSs in a post-coating process. With sizes that have binding properties, CNSs can be formed into larger structures, granules or pellets, for example. In other embodiments the granules or pellets are formed independently of the function of the sizing.

Coating amounts can vary. For instance, relative to the overall weight of the coated CNS material, the coating can be within the range of from about 0.1 weight % to about 10 weight %, e.g., within the range, by weight, of from about 0.1% to about 0.5%; from about 0.5% to about 1%; from about 1% to about 1.5%; from about 1.5% to about 2%; from about 2% to about 2.5%; from about 2.5% to about 3%; from about 3% to about 3.5%; from about 3.5% to about 4%; from about 4% to about 4.5%; from about 4.5% to about 5%; from about 5% to about 5.5%; from about 5.5% to about 6%; from about 6% to about 6.5%; from about 6.5% to about 7%; from about 7% to about 7.5%; from about 7.5% to about 8%; from about 8% to about 8.5%; from about 8.5% to about 9%; from about 9% to about 9.5%; or from about 9.5% to about 10%.

In many cases, controlling the amount of coating (or size) reduces or minimizes undesirable effects on the properties of the CNS material itself.

Various types of coatings can be selected. In many cases, sizing solutions commonly used in coating carbon fibers or glass fibers could also be utilized to coat CNSs. Specific examples of coating materials include but are not limited to fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders, such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. In many implementations, the CNSs used are treated with a polyurethane (PU), a thermoplastic polyurethane (TPU), or with polyethylene glycol (PEG).

Examples of polymers that can be used to coat the primary filler include, but are not limited to, natural rubber latex, emulsion SBR latex, neoprene latex, NBR latex, and/or fluoroelastomer latex. Other examples of polymers that can be used to coat the primary filler and/or be used with the primary filler include, but are not limited to, epoxy, polyester, vinylester, polyetherimide, polyetherketoneketone, polyphthalamide, polyetherketone, polyetheretherketone, polyimide, phenol-formaldehyde, bismaleimide, acrylonitrile-butadiene styrene (ABS), polycarbonate, polyethyleneimine, polyurethane, polyvinyl chloride, polystyrene, polyolefins, polypropylenes, polyethylenes, polytetrafluoroethylene, elastomers such as, for example, polyisoprene, polybutadiene, butyl rubber, nitrile rubber, ethylene-vinyl acetate polymers, silicone polymers, and fluorosilicone polymers, combinations thereof, or other polymers or polymeric blends can also be used in some cases. In order to enhance electrical conductivity, if desired, conductive polymers such as, for instance, polyanilines, polypyrroles and polythiophenes can be used. As an option, polymer that enhance non-conductivity can be used.

Some implementations employ coating materials that can assist in stabilizing a CNS dispersion in a solvent. In one example, the coating is selected to facilitate and/or stabilize dispersing CNSs in a medium that comprises, consists essentially of or consists of N-methylpyrrolidone (NMP), acetone, a suitable alcohol, water or any combination thereof.

As an option, the primary filler (e.g., CNS) can be CNS-materials that have a 97% or higher CNT purity (based on the total weight of the CNS). Typically, anionic, cationic or metal impurities are very low, e.g., in the parts per million (ppm) range. Often, the CNSs used herein require no further additives to counteract Van der Waals' forces.

CNSs can be provided in the form of a loose particulate material (as CNS flakes, granules, pellets, etc., for example) or in compositions that also include a liquid medium, e.g., dispersions, slurries, pastes, or in other forms. In many implementations, the CNSs employed are free of any growth substrate.

In some embodiments, the CNSs are provided in the form of a flake material after being removed from the growth substrate upon which the carbon nanostructures are initially formed. As used herein, the term “flake material” refers to a discrete particle having finite dimensions. Shown in FIG. 1A, for instance, is an illustrative depiction of a CNS flake material after isolation of the CNS from a growth substrate. Flake structure 100 can have first dimension 110 that is in a range from about 50 nm to about 35 μm thick, particularly about 50 nm to about 500 nm thick, including any value in between and any fraction thereof. Flake structure 100 can have second dimension 120 that is in a range from about 1 micron to about 750 microns tall, including any value in between and any fraction thereof. Flake structure 100 can have third dimension 130 that can be in a range from about 1 micron to about 750 microns, including any value in between and any fraction thereof. Two or all of dimensions 110, 120 and 130 can be the same or different.

For example, in some embodiments, second dimension 120 and third dimension 130 can be, independently, on the order of from about 1 micron to about 10 microns, or from about 10 microns to about 100 microns, or from about 100 microns to about 250 microns, or from about 250 to about 500 microns, or from about 500 microns to about 750 microns.

The CNTs within the CNS can vary in length from between about 10 nanometers to about 750 microns, for example. In illustrative implementations, the CNTs are from about 10 nanometers to about 100 nanometers, from about 100 nanometers to about 500 nanometers, from about 500 nanometers to about 1 micron, from about 1 micron to about 10 microns, from about 10 microns to about 100 microns, from about 100 microns to about 250 microns, from about 250 to about 500 microns, or from about 500 microns to about 750 microns.

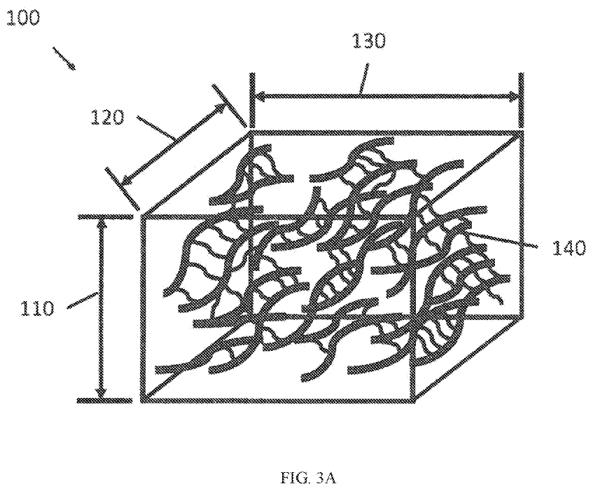

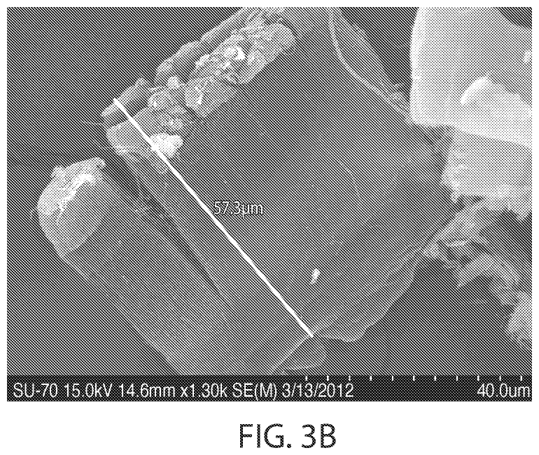

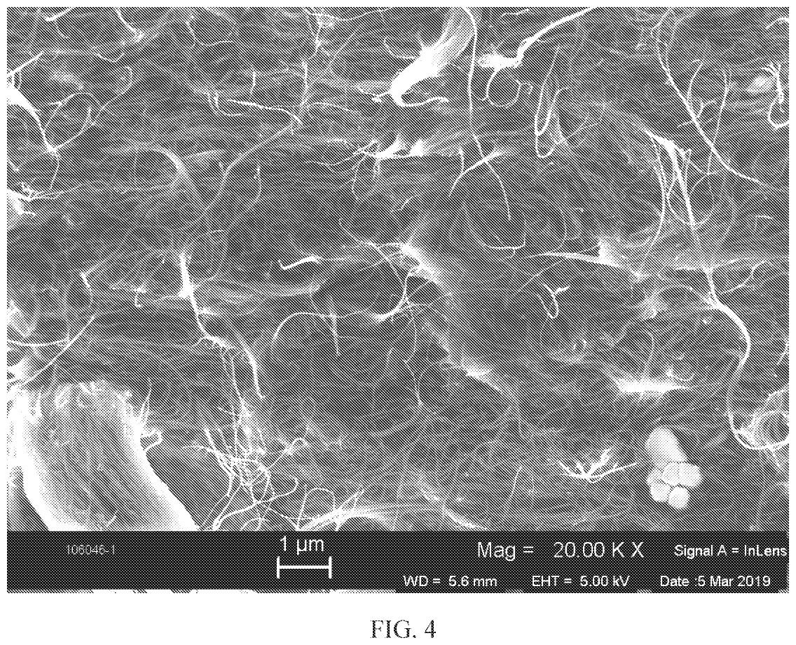

Shown in FIG. 3B is a SEM image of an illustrative carbon nanostructure obtained as a flake material. The carbon nanostructure shown in FIG. 3B exists as a three-dimensional microstructure due to the entanglement and crosslinking of its highly aligned carbon nanotubes. The aligned morphology is reflective of the formation of the carbon nanotubes on a growth substrate under rapid carbon nanotube growth conditions (e.g., several microns per second, such as about 2 microns per second to about 10 microns per second), thereby inducing substantially perpendicular carbon nanotube growth from the growth substrate. Without being bound by any theory or mechanism, it is believed that the rapid rate of carbon nanotube growth on the growth substrate can contribute, at least in part, to the complex structural morphology of the carbon nanostructure. In addition, the bulk density of the carbon nanostructure can be modulated to some degree by adjusting the carbon nanostructure growth conditions, including, for example, by changing the concentration of transition metal nanoparticle catalyst particles that are disposed on the growth substrate to initiate carbon nanotube growth.

A flake structure can include a webbed network of carbon nanotubes in the form of a carbon nanotube polymer (i.e., a “carbon nanopolymer”) having a molecular weight in a range from about 15,000 g/mol to about 150,000 g/mol, including all values in between and any fraction thereof. In some cases, the upper end of the molecular weight range can be even higher, including about 200,000 g/mol, about 500,000 g/mol, or about 1,000,000 g/mol. The higher molecular weights can be associated with carbon nanostructures that are dimensionally long. The molecular weight can also be a function of the predominant carbon nanotube diameter and number of carbon nanotube walls present within the carbon nanostructure. The crosslinking density of the carbon nanostructure can range between about 2 mol/cm³ to about 80 mol/cm³. Typically, the crosslinking density is a function of the carbon nanostructure growth density on the surface of the growth substrate, the carbon nanostructure growth conditions and so forth. It should be noted that the typical CNS structure, containing many, many CNTs held in an open web-like arrangement, removes Van der Wall's forces or diminishes their effect. This structure can be exfoliated more easily, which makes many additional steps of separating them or breaking them into branched structures unique and different from ordinary CNTs.

As another alternative, the flake material can be captured and sprayed with an aqueous solution containing a binder (e.g., polyethylene glycol or polyurethane) to form wet flakes. The weight ratio of aqueous binder solution to the flake material can range from 8:1 to 15:1, e.g., from 10:1 to 15:1, from 10:1 to 13:1, or from 10:1 to 12:1. The wet flakes can then be extruded to form wet extrudates. Drying the wet extrudates (e.g., by air drying, drying in an oven) results in formation of the CNS pellets. Alternatively, drying the wet flakes results in formation of CNS granules.

As an option, where wet fillers are used (as described herein), the wet filler comprising the CNSs as the primary filler can be the wet flakes or wet extrudates, as described above. Alternatively, CNS, provided in the form of a loose particulate material (as CNS flake material, granules pellets, etc., for example) can be wetted with the liquid in the amounts disclosed herein, or can be present in compositions that also include a liquid medium, e.g., dispersions, slurries, pastes, or in other forms.

CNS can have up to 3% residual impurities e.g., residual catalyst and/or glass fiber substrate. In many implementations, the CNSs employed are free of any growth substrate.

With a web-like morphology, carbon nanostructures can have relatively low bulk densities. As-produced carbon nanostructures can have an initial bulk density ranging between about 0.003 g/cm³ to about 0.015 g/cm³. Further consolidation and/or coating to produce a carbon nanostructure flake material or like morphology can raise the bulk density to a range between about 0.1 g/cm³ to about 0.15 g/cm³. In some embodiments, optional further modification of the carbon nanostructure can be conducted to further alter the bulk density and/or another property of the carbon nanostructure. In some embodiments, the bulk density of the carbon nanostructure can be further modified by forming a coating on the carbon nanotubes of the carbon nanostructure and/or infiltrating the interior of the carbon nanostructure with various materials. Coating the carbon nanotubes and/or infiltrating the interior of the carbon nanostructure can further tailor the properties of the carbon nanostructure for use in various applications. Moreover, forming a coating on the carbon nanotubes can desirably facilitate the handling of the carbon nanostructure.

In addition to the flakes described above, the CNS material can be provided as granules, pellets, or in other forms of loose particulate material, having a typical particle size within the range of from about 1 mm to about 1 cm, for example, from about 0.5 mm to about 1 mm, from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm or from about 9 mm to about 10 mm. These particle sizes can be, as an option, considered average particle sizes.

Bulk densities characterizing CNS materials that can be employed can be within the range of from about 0.005 g/cm³ to about 0.3 g/cm³ or from about 0.005 g/cm³ to about 0.1 g/cm³, e.g., from about 0.01 g/cm³ to about 0.05 g/cm³.

Commercially, examples of CNS materials that can be utilized are those developed by Applied Nanostructured Solutions, LLC (ANS), a wholly owned subsidiary of Cabot Corporation (Massachusetts, United States).

The CNSs used herein can be identified and/or characterized by various techniques. Electron microscopy, including techniques such as transmission electron microscopy (TEM) and scanning electron microscopy (SEM), for example, can provide information about the CNSs and the CNSs used herein can be identified and/or characterized by various techniques. Electron microscopy, including techniques such as transmission electron microscopy (TEM) and scanning electron microscopy (SEM), for example, can provide information about features such as the frequency of specific number of walls present, branching, the absence of catalyst particles, etc. See, e.g., FIGS. 2A-2D.

Raman spectroscopy can point to bands associated with impurities. For example, a D-band (around 1350 cm⁻¹) is associated with amorphous carbon; a G band (around 1580 cm⁻¹) is associated with crystalline graphite or CNTs). A G′ band (around 2700 cm⁻¹) is expected to occur at about 2× the frequency of the D band.

In some cases, it may be possible to discriminate between CNS and CNT structures by thermogravimetric analysis (TGA).

In the present invention, the primary filler (e.g., CNS) can be, and preferably is, uniformly distributed in the at least one elastomer. This uniform distribution can be determined by SEM. As used herein, the terms “uniform” and “uniformly” are intended to mean, conventionally for those skilled in the art, that the concentration of a component, for example, particulate filler, in any given fraction or percentage (e.g., 5%) of a volume is the same (e.g., within 2%) as the concentration of that component in the total volume of the material in question, e.g., elastomer composite or dispersion. Those skilled in the art will be able to verify the statistical uniformity of the material, if required, by means of measurements of concentration of the component using several samples taken from various locations (for example near the surface or deeper in the bulk). A filler concentration that does not satisfy this definition would be considered non-uniformly distributed in the elastomer, which may be desired in certain embodiments or applications. For instance, as an option in the present invention, a primary filler can be non-uniformly distributed in an elastomer or matrix, such as in the form of random regions or pockets of primary filler that are non-uniformly distributed in the elastomer or matrix.

The primary filler, namely the CNS(s), can be present in the elastomeric composition at a loading level of from about 0.1 phr to about 50 phr. The loading level can be from 0.1 phr to 40 phr, from 0.1 to 0.5 phr, from 0.1 phr to 30 phr, from 0.1 phr to 20 phr, from 0.1 phr to 10 phr, from 0.1 phr to 5 phr, from 0.1 phr to 3 phr, from 0.1 phr to 2 phr, from 0.1 phr to 1 phr, from 1 phr to 50 phr, from 2 phr to 50 phr, from 5 phr to 50 phr, from 10 phr to 50 phr, or from 20 phr to 50 phr, and other ranges within one or more of these ranges.

The primary filler, namely the CNS(s), can be present in the elastomeric composition at a loading level of from 0.5 phr to 50 phr. The loading level can be from 0.5 phr to 40 phr, from 0.5 phr to 30 phr, from 0.5 phr to 20 phr, from 0.5 phr to 10 phr, from 0.5 phr to 5 phr, from 0.5 phr to 3 phr, from 0.5 phr to 2 phr, from 0.5 phr to 1 phr, from 1 phr to 20 phr, from 1 phr to 10 phr, from 1 phr to 5 phr, from 1 phr to 3 phr, or from 1 phr to 2 phr, or other ranges within one or more of these ranges.

As an option, the primary filler can be the sole or only filler present in the elastomeric composition. Thus, in this option, there is no other filler present except for the primary filler(s).

As an option, one or more secondary fillers can be additionally present in the elastomeric composition along with the primary filler. One additional secondary filler can be present in the elastomeric composition. Or, as an option, two additional secondary fillers, or three or more additional secondary fillers can be present in the elastomeric composition.

The secondary filler(s) can be any filler other than a primary filler, as defined herein. Examples of secondary fillers include, but are not limited to, carbon black (e.g., a furnace black, a gas black, a thermal black, an acetylene black, a plasma black, a reclaimed black, and/or a lamp black), reclaimed carbon, recovered carbon black (e.g., as defined in ASTM D8178-19), rCB, silica-coated carbon black, silica-treated carbon black or silicon-treated carbon black (dual phase carbon-silica filler), silica, clay, nanoclay, mica, kaolin, chalk, calcium carbonate, carbon nanotubes, graphenes, pyrolysis carbon, nanocellulose, carbon fibers, KEVLAR fibers, glass fibers, glass spheres, nylon fibers, graphite, boron nitride, graphite nanoplatelets, metal oxides, or metal carbonates, or combinations thereof. The secondary filler can be or include individualized, pristine CNTs, i.e., CNTs that are not generated or derived from CNSs, e.g., during processing. Another example of a secondary filler is reduced graphene oxides, such as densified reduced graphene oxides, as described in U.S. Provisional Patent Application No. 62/857,296 filed Jun. 5, 2019, and incorporated in its entirety by reference herein. The fillers can be coated or treated (e.g., chemically treated carbon black or silica, or silicon-treated carbon black).

As an option, the secondary filler comprises at least one material selected from carbonaceous materials, carbon black, silica, nanocellulose, lignin, clays, nanoclays, metal oxides, metal carbonates, pyrolysis carbon, mica, kaolin, glass fibers, glass spheres, nylon fibers, graphite, graphite nanoplatelet, boron nitride, graphenes, graphene oxides, reduced graphene oxide, carbon nanotubes, single-wall carbon nanotubes, multiwall carbon nanotubes or combinations thereof, and coated and treated materials thereof. As another option, the secondary filler is carbon black, silica, silicon-treated carbon black, or combinations thereof.

The total loading level of the secondary filler(s), if present, can be any amount, e.g., any amount that that is loaded into the mixture or targeted (on a dry weight basis). For instance, the loading level can be from about 1 phr to about 100 phr, or from about 5 phr to about 80 phr, or from about 10 phr to about 80 phr, or from about 15 phr to about 80 phr, from about 20 phr to about 80 phr, from about 30 phr to about 80 phr, from about 40 phr to about 80 phr, from about 50 phr to about 80 phr, from about 5 phr to 50 phr, from about 5 phr to about 40 phr, from about 5 phr to about 30 phr, from about 5 phr to about 20 phr, or from about 5 phr to about 10 phr and any amounts within any one or more of these ranges. The above phr amounts can also apply to filler dispersed in the elastomer (filler loading).

As an option, the amount of secondary filler (wet, as described herein, or non-wet filler) that is loaded into the mixture can be targeted (on a dry weight basis) to be at least 20 phr, at least 30 phr, at least 40 phr, or range from 20 phr to 250 phr, from 20 phr to 200 phr, from 20 phr to 180 phr, from 20 phr to 150 phr, from 20 phr to 100 phr, from 20 phr to 90 phr, from 20 phr to 80 phr, 30 phr to 200 phr, from 30 phr to 180 phr, from 30 phr to 150 phr, from 30 phr to 100 phr, from 30 phr to 80 phr, from 30 phr to 70 phr, 40 phr to 200 phr, from 40 phr to 180 phr, from 40 phr to 150 phr, from 40 phr to 100 phr, from 40 phr to 80 phr, from 35 phr to 65 phr, or from 30 phr to 55 phr or other amounts within or outside of one or more of these ranges. The above phr amounts can also apply to filler dispersed in the elastomer (filler loading).

With regard to silica, if used, one or more types of silica, or any combination of silica(s), can be used in any embodiment of the present invention. The silica suitable for reinforcing elastomer composites can be characterized by a surface area (BET) of about 20 m²/g to about 450 m²/g; about 30 m²/g to about 450 m²/g; about 30 m²/g to about 400 m²/g; or about 60 m²/g to about 250 m²/g; and for heavy vehicle tire treads a BET surface area of about 60 m²/g to about 250 m²/g or for example from about 80 m²/g to about 200 m²/g. Highly dispersible precipitated silica can be used as the filler in the present methods. Highly dispersible precipitated silica (“HDS”) is understood to mean any silica having a substantial ability to dis-agglomerate and disperse in an elastomeric matrix. Such determinations may be observed in known manner by electron or optical microscopy on thin sections of elastomer composite. Examples of commercial grades of HDS include, Perkasil® GT 3000GRAN silica from WR Grace & Co, Ultrasil® 7000 silica from Evonik Industries, Zeosil® 1165 MP and 1115 MP silica from Solvay S.A., Hi-Sil® EZ 160G silica from PPG Industries, Inc., and Zeopol® 8741 or 8745 silica from Evonik. Conventional non-HDS precipitated silica may be used as well. Examples of commercial grades of conventional precipitated silica include, Perkasil® KS 408 silica from WR Grace & Co, Zeosil® 175GR silica from Solvay S.A., Ultrasil® VN3 silica from Evonik Industries, Hi-Sil® 243 silica from PPG Industries, Inc. and the Hubersil® 161 silica from Evonik. Hydrophobic precipitated silica with surface attached silane coupling agents may also be used. Examples of commercial grades of hydrophobic precipitated silica include Agilon®400, 454, or 458 silica from PPG Industries, Inc. and Coupsil silicas from Evonik Industries, for example Coupsil 6109 silica.

As a secondary filler, a silica-containing filler can be used. Such a filler can have a silica content of at least 1 wt %, at least 5 wt %, at least 10 wt %, at least 15 wt %, at least 20 wt %, at least 25 wt %, at least 30 wt %, at least 35 wt %, at least 40 wt %, at least 50 wt %, at least 60 wt %, at least 70 wt %, at least 80 wt %, at least 90 wt %, or almost 100 wt % or 100 wt %, or from about 1 wt % to about 100 wt %, all based on the total weight of the particle.

Any of the silica(s) or silica-containing filler can be chemically functionalized, such as to have attached or adsorbed chemical groups, such as attached or adsorbed organic groups. Any combination of silica(s) and/or silica-containing filler can be used. The silica can be in part or entirely a silica having a hydrophobic surface, which can be a silica that is hydrophobic or a silica that becomes hydrophobic by rendering the surface of the silica hydrophobic by treatment (e.g., chemical treatment). The hydrophobic surface may be obtained by chemically modifying the silica particle with hydrophobizing silanes without ionic groups, e.g., bis-triethoxysilylpropyltetrasulfide. Such a surface reaction on silica may be carried out in a separate process step before dispersion, or performed in-situ in a silica dispersion. The surface reaction reduces silanol density on the silica surface, thus reducing ionic charge density of the silica particle in the slurry. Suitable hydrophobic surface-treated silica particles for use in dispersions may be obtained from commercial sources, such as Agilon® 454 silica and Agilon® 400 silica, from PPG Industries. Silica dispersions and destabilized silica dispersions may be made using silica particles having low surface silanol density. Such silica may be obtained through dehydroxylation at temperatures over 150° C. via, for example, a calcination process.

With respect to the carbon black, if used, any reinforcing or non-reinforcing grade of carbon black may be selected to yield the desired property in the final rubber composition. Examples of reinforcing grades are N110, N121, N220, N231, N234, N299, N326, N330, N339, N347, N351, N358, and N375. Examples of semi-reinforcing grades are N539, N550, N650, N660, N683, N762, N765, N774, N787, and/or N990.

The carbon black can have any STSA such as ranging from 5 m²/g to 250 m²/g, 11 m²/g to 250 m²/g, 20 m²/g to 250 m²/g or higher, for instance, at least 70 m²/g, such as from 70 m²/g to 250 m²/g, or 80 m²/g to 200 m²/g or from 90 m²/g to 200 m²/g, or from 100 m²/g to 180 m²/g, from 110 m²/g to 150 m²/g, from 120 m²/g to 150 m²/g and the like. As an option, the carbon black can have an Iodine Number (I₂ No) of from about 5 to about 35 mg I₂/g carbon black (per ASTM D1510). The carbon black can be a furnace black or a carbon product containing silicon-containing species, and/or metal containing species and the like. The carbon black can be for purposes of the present invention, a multi-phase aggregate comprising at least one carbon phase and at least one metal-containing species phase or silicon-containing species phase (also known as silicon-treated carbon black, such as ECOBLACK™ materials from Cabot Corporation). As stated, the carbon black can be a rubber black, and especially a reinforcing grade of carbon black or a semi-reinforcing grade of carbon black. Iodine number (I₂ No.) is determined according to ASTM Test Procedure D1510. STSA (statistical thickness surface area) is determined based on ASTM Test Procedure D-5816 (measured by nitrogen adsorption). OAN is determined based on ASTM D1765-10. Carbon blacks sold under the Regal®, Black Pearls®, Spheron®, Sterling®, Emperor®, Monarch®, Shoblack™, Propel®, Endure®, and Vulcan® trademarks available from Cabot Corporation, the Raven®, Statex®, Furnex®, and Neotex® trademarks and the CD and HV lines available from Birla, and the Corax®, Durax®, Ecorax®, and Purex® trademarks and the CK line available from Evonik (Degussa) Industries, and other fillers suitable for use in rubber or tire applications, may also be exploited for use with various implementations. Suitable chemically functionalized carbon blacks include those disclosed in WO 96/18688 and US2013/0165560, the disclosures of which are hereby incorporated by reference. Mixtures of any of these carbon blacks may be employed.

The carbon black can be an oxidized carbon black, such as pre-oxidized using an oxidizing agent. Oxidizing agents include, but are not limited to, air, oxygen gas, ozone, NO₂ (including mixtures of NO₂ and air), peroxides such as hydrogen peroxide, persulfates, including sodium, potassium, or ammonium persulfate, hypohalites such a sodium hypochlorite, halites, halates, or perhalates (such as sodium chlorite, sodium chlorate, or sodium perchlorate), oxidizing acids such a nitric acid, and transition metal containing oxidants, such as permanganate salts, osmium tetroxide, chromium oxides, or ceric ammonium nitrate. Mixtures of oxidants may be used, particularly mixtures of gaseous oxidants such as oxygen and ozone. In addition, carbon blacks prepared using other surface modification methods to introduce ionic or ionizable groups onto a pigment surface, such as chlorination and sulfonation, may also be used. Processes that can be employed to generate pre-oxidized carbon blacks are known in the art and several types of oxidized carbon black are commercially available.

Further, as an option, an amount, such as a minor amount (10 wt % or less, based on a total weight of particulate material) of any non-CNS, non-silica and non-carbon black particles, such as zinc oxide, or calcium carbonate, or other particulate materials useful in rubber compositions.

The total filler loading in the composite, from primary filler(s) alone or with at least one secondary filler can be greater than 0.1 phr, such as from about 1 phr to 250 phr, about 1 phr to 150 phr, such as from about 5 phr to 125 phr, from about 10 phr to about 100 phr, from about 10 phr to about 90 phr, from about 10 to 80 phr, from about 10 to about 70 phr, from about 20 phr to about 70 phr, from about 30 phr to about 70 phr, from about 40 phr to about 100 phr, or any amounts within one or more of these ranges.

As an option, the elastomeric composition has a filler yield loss of no more than 10% on a dry weight basis. The filler yield loss is determined based on the theoretical maximum phr of filler in the elastomeric composition (assuming all filler charged to the mixer is incorporated into the composition or composite) minus the measured phr of filler in the composition or composite discharged. This measured amount can be obtained from thermogravimetric analysis (TGA). Thus, filler yield loss (%) is calculated as:

$$[ \frac{( Theorectical phr filler ) - ( measured phr filler )}{( Theorectical phr filler )} ] \times 100. \qquad ( I )$$

As an option, the process of the present invention does not result in a significant loss of the filler that is originally charged into the mixer. Loose filler present on the surface of the composite due to poor incorporation of the filler into the elastomer is included in the filler yield loss. In any of the methods of the present invention, the filler yield loss can be no more than 10%, such as no more than 9% or no more than 8% or no more than 7% or no more than 6% or no more than 5% or no more than 4% or no more than 3% or no more than 2% or no more than 1%, for instance a filler yield loss of from 0.5% to 10% or 1% to 5%.

As an option, when at least one secondary filler is also present along with the primary filler in the elastomeric composition (e.g., vulcanizate), the at least one primary filler can contribute to at least 50% of at least one mechanical property attribute achieved by the presence of fillers, such as at least 75% of at least one mechanical property attribute achieved by the presence of fillers, or at least 85% of at least one mechanical property attribute achieved by the presence of fillers (for instance, from 50% to 95% or from 50% to 85%, or from 60% to 85%, or from 70% to 85%). The mechanical property can be, e.g., tensile strength, tear strength, tensile modulus, M100, M50, or Mooney viscosity. This % can be determined by forming an elastomeric composition by using a primary filler along with a secondary filler and measuring a mechanical property (property A), and then forming the same elastomeric composition but without the secondary filler present and using the same phr loading for the primary filler, and measuring the same mechanical property (property B) and then conducting a calculation: [(property B)/(property A)]×100, to determine the %.

As an option, in an elastomeric composition (e.g., rubber compound, vulcanizate) of the present invention, at least one primary filler (as the sole filler) is capable of providing a volume resistivity of 10⁷ ohm·cm or less, 10⁶ ohm·cm or less, or 10⁵ ohm·cm or less, or 10⁴ ohm·cm or less, or 103 ohm·cm or less at a loading of 1 phr, to the elastomeric composition, or a loading of 2 wt. %, or at 1.5 wt. %, or at 1 wt. % or even less than 1 wt. %, e.g., at 0.9 wt. %, or at 0.8 wt. %, or at 0.7 wt. %, or at 0.6 wt. %, or at 0.5 wt. %. Or, at least one primary filler (as the sole filler) is capable of providing a volume resistivity of 10⁷ ohm·cm or less, 10⁶ ohm·cm or less, or 10⁵ ohm·cm or less, or 10⁴ ohm·cm or less, or 103 ohm·cm or less to the elastomeric composition at a loading of 2 phr or 1 phr, or a loading of 2 wt. %, or at 1.5 wt. %, or at 1 wt. %, or at 0.9 wt. %, or at 0.8 wt. %, or at 0.7 wt. %, or at 0.6 wt. %, or at 0.5 wt. %. Volume resistivity can be determined according to the method described in the Examples or by ASTM D991 (Rubber Property Volume Resistivity of Electrically Conductive Antistatic Products).

As an option, in the present elastomeric compositions, a combination of properties can be achieved. For instance, for an elastomeric composition with at least one primary filler, a volume resistivity that is lower than 10⁶ ohm·cm can be obtained along with a Mooney viscosity of the elastomeric composition that is lower than 1.2 times the Mooney viscosity of the neat rubber (no filler present) under the same testing conditions.

As an option, when at least one primary filler and at least one secondary filler are used together in the elastomeric composition, the contribution to one or more mechanical properties by the presence of the primary filler (e.g. CNS) based on the loading level used can be appreciated relative to the total filler loading. As disclosed herein, a low amount of the primary filler can contribute a large percentage to the overall mechanical property achieved by multiple fillers being present. This is referred to as the “Impact Number” of the filler. As an option, the at least one primary filler, when present in an elastomeric composition, can have an impact number of 2 or higher, such as from 2 to 50, from 3 to 50, from 4 to 50, from 5 to 50, from 7 to 50, from 10 to 50, from 15 to 50, from 20 to 50, from 30 to 50, from 40 to 50, from 2 to 40, from 2 to 30, from 2 to 20, from 2 to 10, from 2 to 5, and any number within any one or more of these ranges.

The “Impact Number” is defined as follows:

Impact Number=(total filler phr/primary filler phr)×(primary filler mechanical property contribution).

The equation applies where the primary filler loading is greater than 0 phr. In this equation, the filler mechanical property contribution ratio is determined by measuring a mechanical property with the primary filler (e.g. CNS) alone, and also measuring the same mechanical property with primary and secondary fillers present in the same elastomer (using the same phr loading for the primary filler and using the same phr loading for the secondary filler). For instance the primary filler mechanical property contribution can be determined from the following equation:

Primary filler mechanical property contribution=(mechanical property A with only x phr primary filler)/(mechanical property A with x phr primary filler+y phr secondary filler)

Examples of the Impact Number achieved are set forth in some of the working examples herein.

Examples of the mechanical property measured to determine the Impact Number include, but are not limited to, tensile strength, tear strength, M50, or M100.

As an option, the CNS material (in the form of flakes, pellets, granules, for instance) can be provided as a liquid dispersion for purposes of combining with at least one elastomer. In general, the liquid medium can be any liquid, a solvent, for instance, that is suitable for use with the constituents of the compositions described herein and capable of being used to manufacture the intended elastomeric composition. The solvent can be anhydrous, polar and/or aprotic. In some embodiments, the solvent has a high volatility so that, during manufacturing, it can be easily removed (e.g., evaporated), thereby reducing drying time and production costs. Suitable examples include but are not limited to acetone, a suitable alcohol, water or any combination thereof.

In some cases, techniques used to prepare the dispersion or slurry generate CNS-derived species such as “CNS fragments” and/or “fractured CNTs” that become distributed (e.g., homogeneously) in individualized form throughout the dispersion. Except for their reduced sizes, CNS fragments (a term that also includes partially fragmented CNSs) generally share the properties of intact CNS and can be identified by electron microscopy and other techniques, as described above. Fractured CNTs can be formed when crosslinks between CNTs within the CNS are broken, under applied shear, for example. Derived (generated or prepared) from CNSs, fractured CNTs are branched and share common walls with one another.

As an option, pellets, granules, flakes or other forms of CNSs are first dispersed in a liquid medium, e.g., water or other aqueous fluid, generating CNS fragments (including partially fragmented CNSs) and/or fractured CNTs. The dispersion or slurry can be prepared from a starting material such as, for example, uncoated, PU- or PEG-coated CNS, or CNSs having any other polymeric binder coating.

With respect to the one or more elastomers that can be present, any conventional elastomer can be present along with the primary filler. The elastomeric compositions can be considered elastomeric composites or considered rubber compositions or rubber composites.

Exemplary elastomers include, but are not limited to, rubbers, polymers (e.g., homopolymers, copolymers and/or terpolymers) of 1,3-butadiene, styrene, isoprene, isobutylene, 2,3-dialkyl-1,3-butadiene, where alkyl may be methyl, ethyl, propyl, etc., acrylonitrile, ethylene, propylene and the like. The elastomer may have a glass transition temperature (Tg), as measured by differential scanning calorimetry (DSC), ranging from about −120° C. to about 0° C.

Other examples of elastomers include, but are not limited to, natural rubber, solution styrene butadiene rubber (sSBR), emulsion styrene butadiene rubber (ESBR), polybutadiene rubber (BR), butyl rubber, chlorinated butyl rubber (CIIR), brominated butyl rubber (BIIR), polychloroprene rubber, acrylonitrile butadiene rubber (NBR), hydrogenated acrylonitrile butadiene rubber (HNBR), fluoroelastomer (FKM), or perfluoroelastomers (FFKM), Aflas® TFE/P rubber, ethylene propylene diene monomer rubber (EPDM), ethylene/acrylic elastomers (AEM), polyacrylates (ACM), polyisoprene, ethylene-propylene rubber, or any combinations thereof.

Further examples of elastomers include, but are not limited to, solution SBR, styrene-butadiene rubber (SBR), natural rubber and its derivatives such as chlorinated rubber, polybutadiene, polyisoprene, poly(styrene-co-butadiene) and the oil extended derivatives of any of them. Blends of any of the foregoing may also be used. Particular suitable synthetic rubbers include: copolymers of from about 10 to about 70 percent by weight of styrene and from about 90 to about 30 percent by weight of butadiene such as copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl-2-vinylpyridine, 5-ethyl-2-vinylpyridine, 2-methyl-5-vinylpyridine, allyl-substituted acrylates, vinyl ketone, methyl isopropenyl ketone, methyl vinyl either, alphamethylene carboxylic acids and the esters and amides thereof such as acrylic acid and dialkylacrylic acid amide. Also suitable for use herein are copolymers of ethylene and other high alpha olefins such as propylene, 1-butene and 1-pentene.

Also suitable elastomers include, but are not limited to, fluorinated monomers, such as, but not limited to, copolymers of tetrafluoroethylene and propylene, terpolymers of ethylene, tetrafluoroethylene and a perfluoroether (ETP), copolymers of hexafluoropropylene vinylidene fluoride and tetrafluoroethylene, and the like.

As noted further below, the rubber compositions can contain, in addition to the elastomer and filler and coupling agent, various processing aids, oil extenders, antidegradents, and/or other additives.

As an option, a continuously-fed latex and the primary filler (CNSs and/or fragments thereof) such as in the form of a filler slurry, can be introduced and agitated in a coagulation tank. This is also known as a “wet mix” technique. The latex and filler slurry can be mixed and coagulated in the coagulation tank into small beads, referred to as “wet crumb.” The various general processes and techniques described in U.S. Pat. Nos. 4,029,633; 3,048,559; 6,048,923; 6,929,783; 6,908,961; 4,271,213; 5,753,742; and 6,521,691 can be used for this combination of primary filler with elastomer and coagulation of the latex. Each of these patents are incorporated in their entirety by reference herein. This type of elastomeric formulation can be used with the primary filler using the various techniques, formulations, and other parameters described in these patents and processes, except that the primary filler, as described herein, is used.

Exemplary natural rubber latices include, but are not limited to, field latex, latex concentrate (produced, for example, by evaporation, centrifugation or creaming), skim latex (e.g., the supernatant remaining after production of latex concentrate by centrifugation) and blends of any two or more of these in any proportion. The latex should be appropriate for the wet masterbatch process selected and the intended purpose or application of the final rubber product. The latex is provided typically in an aqueous carrier liquid. Selection of a suitable latex or blend of latices will be well within the ability of those skilled in the art given the benefit of the present disclosure and the knowledge of selection criteria generally well recognized in the industry.

When mixing fillers and elastomers, a challenge is to ensure the mixing time is long enough to ensure sufficient filler incorporation and dispersion before the elastomer in the mixture experiences high temperatures and undergoes degradation. In typical dry mix methods, the mix time and temperature are controlled to avoid such degradation and the ability to optimize filler incorporation and dispersion is often not possible.

PCT Application No. PCT/US2020/036168, filed Jun. 4, 2020, the disclosure of which is incorporated by reference herein, describes a mixing process with solid elastomer and a wet filler (e.g., comprising a filler and a liquid) to enable the batch time and temperature to be controlled beyond that attainable with known dry mixing processes. Other benefits may be attained, such as enhancing filler dispersion and/or facilitating rubber-filler interactions and/or improving rubber compound properties compared to conventionally mixed masterbatches when they are compounded and vulcanized, as reflected in one or more rubber properties.

Disclosed herein are methods that incorporate the use of a wet filler in a mixing process with solid elastomer. The composite formed by the methods disclosed herein can be considered an uncured mixture of filler(s) and elastomer(s), optionally along with other additives. The composite formed can be considered a mixture or masterbatch. The composite formed can be, as an option, an intermediate product that can be used in subsequent rubber compounding and one or more vulcanization processes. The composite, prior to the compounding and vulcanization, can also be subjected to additional processes, such as one or more holding steps or further mixing step(s), one or more additional drying steps, one or more extruding steps, one or more calendaring steps, one or more milling steps, one or more granulating steps, one or more baling steps, one or more twin-screw discharge extruding steps, or one or more rubber working steps to obtain a rubber compound or a rubber article.

The methods for preparing a composite include the step of charging or introducing into a mixer at least a solid elastomer and a wet filler, e.g., a) one or more solid elastomers and b) one or more fillers wherein at least one filler or a portion of at least one filler has been wetted with a liquid prior to mixing with the solid elastomer (wet filler). The combining of the solid elastomer with wet filler forms a mixture during the mixing step(s). The method further includes, in one or more mixing steps, conducting said mixing wherein at least a portion of the liquid is removed by evaporation or an evaporation process that occurs during the mixing. The liquid of the wet filler is capable of being removed by evaporation (and at least a portion is capable of being removed under the claimed mixing conditions) and can be a volatile liquid, e.g., volatile at bulk mixture temperatures.

As an option, the wet filler has the consistency of a solid. As an option, a dry filler is wetted only to an extent such that the resulting wet filler maintains the form of a powder, particulates, pellet, cake, or paste, or similar consistency and/or has the appearance of a powder, particulates, pellet, cake, or paste (or otherwise a malleable solid). The wet filler does not flow like a liquid (at zero applied stress). As an option, the wet filler can maintain a shape at 25° C. when molded into such a shape, whether it be the individual particles, agglomerates, pellets, cakes, or pastes. The wet filler is not a composite made by a liquid masterbatch process and is not any other pre-blended composite of filler dispersed in a solid elastomer (from elastomer in a liquid state) in which the elastomer is the continuous phase.

In another embodiment, the wet filler can be a slurry.

In the methods disclosed herein, at least the solid elastomer and wet filler are charged (e.g. fed, introduced) into the mixer. The charging of the solid elastomer and/or the filler can occur in one or multiple steps or additions. The charging can occur in any fashion including, but not limited to, conveying, metering, dumping and/or feeding in a batch, semi-continuous, or continuous flow of the solid elastomer and the wet filler into the mixer. The charging of the solid elastomer and the wet filler can occur all at once, or sequentially, and can occur in any sequence. For example, (a) all solid elastomer added first, (b) all wet filler added first, (c) all solid elastomer added first with a portion of wet filler followed by the addition of one or more remaining portions of wet filler, (d) a portion of solid elastomer added and then a portion of wet filler added, (e) at least a portion of the wet filler is added first followed by at least a portion of the solid elastomer, or (f) at the same time or about the same time, a portion of solid elastomer and a portion of wet filler are added as separate charges to the mixer. Other applicable methods of charging the mixer with the solid elastomer and wet filler are disclosed in PCT Application No. PCT/US2020/036168, filed Jun. 4, 2020, the disclosure of which is incorporated by reference herein.

As an option, the method comprises (a) charging a mixer with at least a solid elastomer and a wet filler comprising at least one primary filler and a liquid present in an amount of at least 50% by weight based on total weight of wet filler. As another option, the method comprises (a) charging a mixer with at least a solid elastomer, at least one primary filler, and a wet filler comprising at least one secondary filler and a liquid present in an amount of at least 15% by weight based on total weight of wet filler. Thus, in these embodiments, the at least one primary filler or at least one secondary filler can be wet or non-wet so long as at least one of the primary filler and the secondary filler is a wet filler.

For the present wet filler comprising the primary filler, liquid or additional liquid can be added to the filler and is present on a substantial portion or substantially all the surfaces of the filler, which can include inner surfaces or pores accessible to the liquid. Thus, sufficient liquid is provided to wet a substantial portion or substantially all of the surfaces of the filler prior to mixing with solid elastomer. During mixing, at least a portion of the liquid can also be removed by evaporation as the wet filler is being dispersed in the solid elastomer, and the surfaces of the filler can then become available to interact with the solid elastomer. The wet filler comprising the primary filler can have a liquid content of at least 50% by weight relative to the total weight of the wet filler, e.g., at least 60%, at least 70%, at least 80%, or at least 90% by weight, or from 50% to 99%, from 50% to 95%, from 50% to 90%, from 50% to 80%, from 60% to 99%, from 60% to 95%, from 60% to 90%, from 60% to 80%, from 70% to 99%, from 70% to 95%, from 70% to 90%, from 70% to 80%, from 80% to 99%, from 80% to 95%, from 80% to 90%, or from 90% to 99% by weight, relative to the total weight of the wet filler. Commercially available CNS (e.g., dry CNS) has a water content of 2 wt. % or less.

The liquid used to wet the filler can be, or include, an aqueous liquid, such as, but not limited to, water. The liquid can include at least one other component, such as, but not limited to, a base(s), an acid(s), a salt(s), a solvent(s), a surfactant(s), a coupling agent(s) (e.g., if the filler further comprises silica), and/or a processing aid(s) and/or any combinations thereof. More specific examples of the component are NaOH, KOH, acetic acid, formic acid, citric acid, phosphoric acid, sulfuric acid, or any combinations thereof. For example, the base can be selected from NaOH, KOH, and mixtures thereof, or the acids can be selected from acetic acid, formic acid, citric acid, phosphoric acid, or sulfuric acid, and combinations thereof. The liquid can be or include a solvent(s) that is immiscible with the elastomer used (e.g., alcohols such as ethanol). Alternatively, the liquid consists of from about 80 wt. % to 100 wt. % water or from 90 wt. % to 99 wt. % water based on the total weight of the liquid.

As an option, pellets, granules, flakes or other forms of CNSs can be combined with a liquid medium, e.g., water or other aqueous fluid, in desired amounts to generate the wet filler. Alternatively, intermediates of CNS, e.g., wet extrudates or wet flakes, are in themselves a wet filler and can be used, either as is or in combination with a binder, e.g., polyurethane or polyethylene glycol.

The at least one secondary filler can be provided as a conventional dry filler or as a second wet filler. In their dry state, fillers may contain no or small amounts of liquid (e.g. water or moisture) adsorbed onto its surfaces, e.g., a water content ranging from 0.1% to 7% by weight. For example, carbon black can have 0 wt. %, or 0.1 wt. % to 1 wt. % or up to 3 wt. % or up to 4 wt. % of liquid and precipitated silica can have a liquid (e.g., water or moisture) content of from 4 wt. % to 7 wt. % liquid, e.g., from 4 wt. % to 6 wt. % liquid. Such fillers, are referred to herein as dry or non-wetted fillers.

As another option, the secondary filler can be a wet filler. Where the wet filler comprising the primary filler is a first wet filler, a second wet filler can comprise the secondary filler and liquid present in an amount of at least 15% by weight based on total weight of the second wet filler. Alternatively, only the secondary filler is a wet filler. The wet filler (or second wet filler) can comprise two or more secondary fillers, each comprising the liquid present in an amount of at least 15% by weight. As another option, the wet filler, or second wet filler (e.g., carbon black, silica, silicon-treated black, and combinations thereof), can have a liquid content of at least 20% by weight relative to the total weight of the wet filler, e.g., at least 25%, at least 30%, at least 40%, at least 50% by weight, or from 15% to 99%, from 15% to 95%, from 15% to 90%, from 15% to 80%, from 15% to 70%, from 15% to 60%, from 20% to 99%, from 20% to 95%, from 20% to 90%, from 20% to 80%, from 20% to 70%, from 20% to 60%, from 30% to 99%, from 30% to 95%, from 30% to 90%, from 30% to 80%, from 30% to 70%, from 30% to 60%, from 40% to 99%, from 40% to 95%, from 40% to 90%, from 40% to 80%, from 40% to 70%, from 40% to 60%, from 45% to 99%, from 45% to 95%, from 45% to 90%, from 45% to 80%, from 45% to 70%, from 45% to 60%, from 50% to 99%, from 50% to 95%, from 50% to 90%, from 50% to 80%, from 50% to 70%, or from 50% to 60% by weight, relative to the total weight of the wet filler.

In addition to one or more wet fillers (e.g., first and second wet fillers) that are charged to the mixer, the secondary filler can comprise conventional (dry or non-wetted) fillers that can also be charged to the mixer to form a composite comprising a blend of fillers obtained from a combination of wet fillers and dry fillers that are charged to the mixer. When non-wetted filler is present, the total amount of filler can be such that at least 10%, at least 20%, at least 30%, at least 40%, at least 50% or at least 60%, at least 70%, at least 80%, at least 90%, at least 95% by weight of the total weight of filler is a wet filler (e.g., wet filler comprising the primary filler, or a total of first and second (or more) wet fillers), such as from 10% to 99%, from 20% to 99%, from 30% to 99%, from 40% to 99%, from 50% to 99%, from 60% to 99%, from 70% to 99%, from 80% to 99%, from 90% to 99%, or from 95% to 99% of the total amount of filler can be wet filler, with the balance of the filler being in a non-wetted state or not being considered a wet filler.

Other fillers (wet or non-wetted), blends, combinations, etc. can be used, such as those disclosed in are disclosed in PCT Application No. PCT/US2020/036168, filed Jun. 4, 2020, or U.S. Provisional Application No. 63/012,328, filed Apr. 20, 2020, the disclosures of which are incorporated by reference herein. The manufacture and properties of these silicon-treated carbon blacks are described in U.S. Pat. No. 6,028,137, the disclosure of which is incorporated herein by reference.

With regard to the solid elastomer that is used and mixed with the wet filler, the solid elastomer can be considered a dry elastomer or substantially dry elastomer. The solid elastomer can have a liquid content (e.g., solvent or water content) of 5 wt. % or less, based on the total weight of the solid elastomer, such as 4 wt. % or less, 3 wt. % or less, 2 wt. % or less, 1 wt. % or less, or from 0.1 wt. % to 5 wt. %, 0.5 wt. % to 5 wt. %, 0.5 wt. % to 4 wt. %, 0.5 wt. % to 3 wt. %, 0.5 wt. % to 2 wt. %, 1 wt. % to 5 wt. %, 1 wt. % to 3 wt. %, 1 wt. % to 2 wt. %, and the like. The solid elastomer (e.g., the starting solid elastomer) can be entirely elastomer (with the starting liquid, e.g., water, content of 5 wt. % or less) or can be an elastomer that also includes one or more fillers and/or other components. For instance, the solid elastomer can be from 50 wt. % to 99.9 wt. % elastomer with 0.1 wt. % to 50 wt. % filler predispersed in the elastomer in which the predispersed filler is in addition to the wet filler. Such elastomers can be prepared by dry mixing processes between non-wetted filler and solid elastomers.

Solid elastomers can be natural elastomers, synthetic elastomers, and blends thereof. For example, the solid elastomers can be selected from natural rubber, functionalized natural rubber, styrene-butadiene rubber, functionalized styrene-butadiene rubber, polybutadiene rubber, functionalized polybutadiene rubber, polyisoprene rubber, ethylene-propylene rubber, isobutylene-based elastomers, polychloroprene rubber, nitrile rubber, hydrogenated nitrile rubber, polysulfide rubber, polyacrylate elastomers, fluoroelastomers, perfluoroelastomers, silicone elastomers, and blends thereof. As an option, the solid elastomer can be selected from natural rubber, styrene-butadiene rubber, functionalized styrene-butadiene rubber, and polybutadiene rubber.

Blends of any of the foregoing may also be used.

Any number of methods can be used to combine one or more wet fillers (optionally in combination with one or more dry fillers), with one or more solid elastomers. The step of combining can optionally involve or include forming a masterbatch by combining the at least one elastomer and the at least one primary filler and combining the masterbatch with at least one secondary filler. Where primary and secondary fillers are involved, these can be charged to the mixer separately or as a blend or as co-pellets in one or more portions. In addition to the solid elastomer and wet filler, the mixer can be charged with one or more charges of at least one additional elastomer to form a composite blend. As another option, the process can comprise mixing the discharged composite with additional elastomer and/or additional filler to form the blend. The at least one additional elastomer can be the same as the solid elastomer or different from the solid elastomer. In any of these options, at least one anti-degradant can also be included.

One or more coupling agents can be used in the present invention. The coupling agent can be or include one or more silane coupling agents, one or more zirconate coupling agents, one or more titanate coupling agents, one or more nitro coupling agents, or any combination thereof. The coupling agent can be or include bis(3-triethoxysilylpropyl)tetrasulfane (e.g., Si 69® organosilane from Evonik Industries, Struktol SCA98 from Struktol Company), bis(3-triethoxysilylpropyl)disulfane (e.g., Si 75 and Si 266 from Evonik Industries, Struktol SCA985 from Struktol Company), 3-thiocyanatopropyl-triethoxy silane (e.g., Si 264 from Evonik Industries), gamma-mercaptopropyl-trimethoxy silane (e.g., VP Si 163 from Evonik Industries, Struktol SCA989 from Struktol Company), gamma-mercaptopropyl-triethoxy silane (e.g., VP Si 263 from Evonik Industries), zirconium dineoalkanolatodi(3-mercapto) propionato-O, N,N′-bis(2-methyl-2-nitropropyl)-1,6-diaminohexane, NXT silane coupling agent (a thiocarboxylate functional silane: 3-Octanoylthio-1-propyltriethoxysilane) from Momentive Performance Materials, Wilton, Conn., and/or coupling agents that are chemically similar or that have the one or more of the same chemical groups. Additional specific examples of coupling agents, by commercial names, include, but are not limited to, VP Si 363 from Evonik Industries. The coupling agent can be present in any amount in the elastomer composite. For instance, the coupling agent can be present in the elastomer composite in an amount of at least 0.2 parts per hundred parts of filler (by mass), from about 0.2 to 60 parts per hundred of filler, from about 1 to 30 parts per hundred of filler, from about 2 to 15 parts per hundred of filler, or from about 5 to 10 parts per hundred of filler.

One or more antioxidants can be used in any of the processes of the present invention. The antioxidant (an example of a degradation inhibitor) can be an amine type antioxidant, phenol type antioxidant, imidazole type antioxidant, metal salt of carbamate, para-phenylene diamine(s) and/or dihydrotrimethylquinoline(s), polymerized quinine antioxidant, and/or wax and/or other antioxidants used in elastomer formulations. Specific examples include, but are not limited to, N-(1,3-dimethylbutyl)-N′-phenyl-p-phenylenediamine (6-PPD, e.g., ANTIGENE 6C, available from Sumitomo Chemical Co., Ltd. and NOCLAC 6C, available from Ouchi Shinko Chemical Industrial Co., Ltd.), “Ozonon” 6C from Seiko Chemical Co., Ltd., polymerized 1,2-dihydro-2,2,4-trimethyl quinoline, Agerite Resin D, available from R. T. Vanderbilt, butylhydroxytoluene (BHT), and butylhydroxyanisole (BHA), and the like. Other representative antioxidants may be, for example, diphenyl-p-phenylenediamine and others such as, for example, those disclosed in The Vanderbilt Rubber Handbook (1978), pages 344-346, which is incorporated in its entirety by reference herein. An antioxidant and an antiozonate are collectively degradation inhibitors. These degradation inhibitors illustratively include a chemical functionality, such as an amine, a phenol, an imidazole, a wax, a metal salt of an imidazole, and combinations thereof. Specific degradation inhibitors operative herein illustratively include N-isopropyl-N′-phenyl-p-phenylenediamine, N-(1-methylheptyl)-N′-phenyl-p-phenylenediamine, 6-ethoxy-2,2,4-trimethyl-1,2-dihydroquinoline, N,N′-diphenyl-p-phenylenediamine, octylated diphenylamine, 4,4′-bis(a,a′-dimethylbenzyl)diphenylamine, 4,4′-dicumyl-diphenylamine, 2,5-di-tert-butyl-hydroquinone, 2,2′-methylene-bis(4-methyl-6-tert-butylphenol), 2,2′-methylenebis(4-methyl-6-methylcyclohexlphenol), 4,4′-thio-bis(3-methyl-6-tert-butylphenol), 4,4′-butylidene-bis(3-methyl-6-tert-butylphenol), tris(nonylated phenyl)phosphite, tris-(2,4-di-t-butylphenyl)phosphite, 2-mercaptobenzimidazole, and zinc 2-mercaptobenzimidazole. An example includes at least one amine and one imidazole. Optionally, a polymerized quinoline can be used. The relative amounts of antioxidants can include 0.5 to 3 parts amine, 0.5 to 2.5 parts imidazole, and 0.5 to 1.5 parts of optional polymerized quinoline. The degradation inhibiting amine can be 4,4′-bis(alpha-dimethylbenzyl)diphenylamine, the imidazole can be zinc 2-mercaptotoluimidazole and the polymerized quinoline can be polymerized 1,2-dihydro-2,2,4-trimethylquinoline. In general, the degradation inhibitors (e.g., the antioxidant(s)) are typically present from 0.1 to 20 parts by weight per 100 parts by weight of polymer or rubber system (phr). Typical amounts of antioxidants may comprise, for example, from about 1 to about 5 phr.

The one or more elastomers and primary filler can be combined with conventional tire compound ingredients and additives, such as rubbers, processing aids, accelerators, cross-linking and curing materials, antioxidants, antiozonants, secondary filler(s), resins, etc. to make tire compounds. Processing aids include, but are not limited to, plasticizers, tackifiers, extenders, chemical conditioners, homogenizing agents, and peptizers such as mercaptans, synthetic oil, petroleum and vegetable oils, resins, rosins, and the like. Accelerators include amines, guanidines, thioureas, thiurams, sulfenamides, thiocarbamates, xanthates, benzothiazoles and the like. Cross-linking and curing agents include peroxides, sulfur, sulfur donors, accelerators, zinc oxide, and fatty acids. Secondary fillers include carbon black, clay, bentonite, titanium dioxide, talc, calcium sulfate, silica, and/or silicates and/or mixtures thereof.

Any conventional mixing procedure can be used to combine the primary filler with other components of an elastomer composite. Typical procedures used for rubber compounding are described in Maurice Morton, RUBBER TECHNOLOGY 3^{rd} Edition, Van Norstrand Reinhold Company, New York 1987, and 2^{nd} Edition, Van Nordstrand Reinhold Company, New York 1973 (incorporated in its entirety by reference herein). The mixture of components can be thermomechanically mixed together at a temperature between 120° C. and 180° C.

Elastomeric composites of the present invention can be obtained by suitable techniques that employ, for instance, mixing in a single step or in multiple steps in an internal mixer, such as a Banbury, Intermesh mixers, extruder, on a mill or by utilizing other suitable equipment, to produce a homogenized blend. Specific implementations use techniques such as those described in U.S. Pat. No. 5,559,169, published Sep. 24, 1996 which is incorporated herein by reference in its entirety.

Curing can be conducted by techniques known in the art. The elastomeric composition can be a cured elastomeric composition, such as sulfur-cured, peroxide-cured and so forth.

Conventional techniques that are well known to those skilled in the art can be used to prepare the elastomeric compositions and to incorporate the primary filler. Any conventional dry mixing or liquid mixing technique (e.g. liquid masterbatch technique). The mixing of the rubber or elastomer compound can be accomplished by methods known to those having skill in the rubber mixing art. For example, the ingredients are typically mixed in at least two stages, namely at least one non-productive stage followed by a productive mix stage. The final curatives are typically mixed in the final stage which is conventionally called the “productive” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. Wet masterbatch methods for producing filled elastomeric compositions, such as those disclosed in U.S. Pat. Nos. 5,763,388, 6,048,923, 6,841,606, 6,646,028, 6,929,783, 7,101,922, and 7,105,595 may also be employed to produce elastomeric compositions according to various embodiments of the invention, and these patents are incorporated in their entirety by reference herein.

With regard to the mixer that can be used in any of the methods disclosed herein, any suitable mixer can be utilized that is capable of combining (e.g., mixing together or compounding together) a filler with solid elastomer. The mixer(s) can be a batch mixer or a continuous mixer. A combination of mixers and processes can be utilized in any of the methods disclosed herein, and the mixers can be used sequentially, in tandem, and/or integrated with other processing equipment. The mixer can be an internal or closed mixer or an open mixer, or an extruder or a continuous compounder or a kneading mixer or a combination thereof. The mixer can be capable of incorporating filler and into solid elastomer and/or capable of dispersing the filler in the elastomer and/or distributing the filler in the elastomer.

The mixer can have one or more rotors (at least one rotor). The at least one rotor or the one or more rotors can be screw-type rotors, intermeshing rotors, tangential rotors, kneading rotor(s), rotors used for extruders, a roll mill that imparts significant total specific energy, or a creping mill. Generally, one or more rotors are utilized in the mixer, for example, the mixer can incorporate one rotor (e.g., a screw type rotor), two, four, six, eight, or more rotors. Sets of rotors can be positioned in parallel and/or in sequential orientation within a given mixer configuration.

With regard to mixing, the mixing can be performed in one or more mixing steps. Mixing commences when at least the solid elastomer and wet filler are charged to the mixer and energy is applied to a mixing system that drives one or more rotors of the mixer. The one or more mixing steps can occur after the charging step is completed or can overlap with the charging step for any length of time. For example, a portion of one or more of the solid elastomers and/or wet filler can be charged into the mixer before or after mixing commences. The mixer can then be charged with one or more additional portions of the solid elastomer and/or filler. For batch mixing, the charging step is completed before the mixing step is completed.

As an option, control over mixer surface temperatures, by whichever mechanism(s), can provide an opportunity for longer mixing or residence times, which can result in improved filler dispersion and/or improved rubber-filler interactions and/or consistent mixing and/or efficient mixing, compared to mixing processes without temperature control of at least one mixer surface.

The temperature-control means can be, but is not limited to, the flow or circulation of a heat transfer fluid through channels in one or more parts of the mixer. For example, the heat transfer fluid can be water or heat transfer oil. For example, the heat transfer fluid can flow through the rotors, the mixing chamber walls, the ram, and the drop door. In other embodiments, the heat transfer fluid can flow in a jacket (e.g., a jacket having fluid flow means) or coils around one or more parts of the mixer. As another option, the temperature control means (e.g., supplying heat) can be electrical elements embedded in the mixer. The system to provide temperature-control means can further include means to measure either the temperature of the heat transfer fluid or the temperature of one or more parts of the mixer. The temperature measurements can be fed to systems used to control the heating and cooling of the heat transfer fluid. For example, the desired temperature of at least one surface of the mixer can be controlled by setting the temperature of the heat transfer fluid located within channels adjacent one or more parts of the mixer, e.g., walls, doors, rotors, etc.

The temperature of the at least one temperature-control means can be set and maintained, as an example, by one or more temperature control units (“TCU”). This set temperature, or TCU temperature, is also referred to herein as “T_{z}.” In the case of temperature-control means incorporating heat transfer fluids, T_{z} is an indication of the temperature of the fluid itself.

As an option, the temperature-control means can be set to a temperature, T_{z}, ranging from 30° C. to 150° C., from 40° C. to 150° C., from 50° C. to 150° C., or from 60° C. to 150° C., e.g., from 30° C. to 155° C., from 30° C. to 125° C., from 40° C. to 125° C., from 50° C. to 125° C., from 60° C. to 125° C., from 30° C. to 110° C., from 40° C. to 110° C., from 50° C. to 110° C., 60° C. to 110° C., from 30° C. to 100° C., from 40° C. to 100° C., from 50° C. to 100° C., 60° C. to 100° C., from 30° C. to 95° C., from 40° C. to 95° C., from 50° C. to 95° C., 50° C. to 95° C., from 30° C. to 90° C., from 40° C. to 90° C., from 50° C. to 90° C., from 65° C. to 95° C., from 60° C. to 90° C., from 70° C. to 110° C., from 70° C. to 100° C., from 70° C. to 95° C., 70° C. to 90° C., from 75° C. to 110° C., from 75° C. to 100° C., from 75° C. to 95° C., or from 75° C. to 90° C. Other ranges, such as a T_{z} of 65° C. or higher, or 70° C. or higher, or 75° C. or higher, or 80° C. or higher, or 90° C. or higher are possible with equipment available in the art.

Compared to dry mixing, under similar situations of filler type, elastomer type, and mixer type, the present processes can allow higher energy input. Controlled removal of the water from the mixture enables longer mixing times and consequently improves the dispersion of the filler. As described herein, the present process provides operating conditions that balance longer mixing times with evaporation or removal of water in a reasonable amount of time.

Other operating parameters to be considered include the maximum pressure that can be used. Pressure affects the temperature of the filler and rubber mixture. If the mixer is a batch mixer with a ram, the pressure inside the mixer chamber can be influenced by controlling the pressure applied to the ram cylinder.

As another option, rotor tip speeds can be optimized. The energy inputted into the mixing system is a function, at least in part, of the speed of the at least one rotor and rotor type. Tip speed, which takes into account rotor diameter and rotor speed, can be calculated according to the formula:

Tip speed, m/s=π×(rotor diameter, m)×(rotational speed, rpm)/60.

As tip speeds can vary over the course of the mixing, as an option, the tip speed of at least 0.5 μm/s or at least 0.6 μm/s is achieved for at least 50% of the mixing time, e.g., at least 60%, at least 70%, at least 75%, at least 80%, at least 85%, at least 90%, at least 95%, or substantially all of the mixing time. The tip speed can be at least 0.6 μm/s, at least 0.7 μm/s, at least 0.8 μm/s, at least 0.9 μm/s, at least 1.0 μm/s, at least 1.1 μm/s, at least 1.2 μm/s, at least 1.5 μm/s or at least 2 μm/s for at least 50% of the mixing time, or other portions of the mixing listed above. The tip speeds can be selected to minimize the mixing time, or can be from 0.6 μm/s to 10 μm/s, from 0.6 μm/s to 8 μm/s, from 0.6 to 6 μm/s, from 0.6 μm/s to 4 μm/s, from 0.6 μm/s to 3 μm/s, from 0.6 μm/s to 2 μm/s, from 0.7 μm/s to 4 μm/s, from 0.7 μm/s to 3 μm/s, from 0.7 μm/s to 2 μm/s, from 0.7 μm/s to 10 μm/s, from 0.7 μm/s to 8 μm/s, from 0.7 to 6 μm/s, from 1 μm/s to 10 μm/s, from 1 μm/s to 8 μm/s, from 1 μm/s to 6 μm/s, from 1 μm/s to 4 μm/s, from 1 μm/s to 3 μm/s, or from 1 μm/s to 2 μm/s, (e.g., for at least 50% of the mixing time or other mixing times described herein).

Any one or combination of commercial mixers with one or more rotors, temperature control means, and other components, to produce rubber compounds can be used in the present methods, such as those disclosed in PCT Application No. PCT/US2020/036168, filed Jun. 4, 2020, the disclosure of which is incorporated by reference herein.

By “one or more mixing steps,” it is understood that the steps disclosed herein may be a first mixing step followed by further mixing steps prior to discharging. The one or more mixing steps can be a batch process or a continuous process. The one or more mixing steps can be a single mixing step, e.g., a one-stage or single stage mixing step or process, in which the mixing is performed under one or more of the following conditions: at least one of the mixer temperatures are controlled by temperature controlled means with one or more rotors operating at a tips speed of at least 0.6 μm/s for at least 50% of mixing time, and/or the at least one temperature-control means that is set to a temperature, Tz, of 65° C. or higher, and/or continuous mixing (continuous process), and/or the mixing is carried out in the substantial absence of the one or more rubber chemicals prior to the mixer reaching an indicated temperature; each is described in further detail herein. In certain instances, in a single stage or single mixing step the composite can be discharged with a liquid content of no more than 20% by weight, e.g., no more than 10% by weight. In other embodiments, two or more mixing steps or mixing stages can be performed so long as one of the mixing steps is performed under one or more of the stated conditions.

As indicated, during the one or more mixing steps, in any of the methods disclosed herein, at least some liquid present in the mixture and/or wet filler introduced is removed at least in part by evaporation. As an option, the one or more mixing steps or stages can further remove a portion of the liquid from the mixture by expression, compaction, and/or wringing, or any combinations thereof. Alternatively, a portion of the liquid can be drained from the mixer after or while the composite is discharged.

During the mixing cycle, after much of the liquid has been released from the composite and the filler incorporated, the mixture experiences an increase in temperature. It is desired to avoid excessive temperature increases that would degrade the elastomer. Discharging, (e.g., “dumping” in batch mixing), can occur on the basis of time or temperature or specific energy or power parameters selected to minimize such degradation.

In any methods disclosed herein, the discharging step from the mixer occurs and results in a composite comprising the filler (e.g., the filler that includes at least the primary filler) dispersed in the solid elastomer at a total loading of at least 0.5 phr, at least 1 phr, at least 2 phr, at least 3 phr, at least 5 phr, e.g., from 0.5 to 250 phr. This loading can occur, as an example, when wet CNS added to target a loading of at least 0.5 phr and no secondary filler is charged to the mixer. In other methods disclosed herein, the discharging step from the mixer occurs and results in a composite comprising the filler (e.g., the filler that includes at least the primary filler) dispersed in the solid elastomer at a total loading of at least 20 phr, e.g., from 20 to 250 phr, or other loadings disclosed herein. For example, wet CNS can be charged to the mixer to target a loading of at least 20 phr and optionally adding secondary filler (wet or dry secondary filler). As another example, wet CNS can be charged to the mixer to target a CNS loading ranging from 0.5 to 10 phr or from 0.5 to 5 phr, and secondary filler (wet or dry secondary filler) is also charged to the mixer for a total filler loading of at least 20 phr (e.g., from 20 phr to 250 phr). Other loadings are possible and are disclosed herein.

As an option, discharging occurs on the basis of a defined mixing time. The mixing time between the start of the mixing and discharging can be about 1 minute or more, such as from about 1 minute to 40 minutes, from about 1 minute to 30 minutes, from about 1 minute to 20 minutes, or from 1 minute to 15 minutes, or from 3 minutes to 30 minutes, from 5 minutes to 30 minutes, or from 5 minutes to 20 minutes, or from 5 minutes to 15 minutes, or from 1 minute to 12 minutes, or from 1 minute to 10 minutes or other times. Alternatively, for batch internal mixers, ram down time can be used as a parameter to monitor batch mixing times, e.g., the time that the mixer is operated with the ram in its lowermost position e.g., fully seated position or with ram deflection as described herein. Ram down time can be less than 30 min., less than 15 min., less than 10 min., or ranges from 3 min. to 30 min or from 5 min. to 15 min, or from 5 min. to 10 min. As an option, discharging occurs on the basis of dump or discharge temperature. For example, the mixer can have a dump temperature ranging from 120° C. to 190° C., 130° C. to 180° C., such as from 140° C. to 180° C., from 150° C. to 180° C., from 130° C. to 170° C., from 140° C. to 170° C., from 150° C. to 170° C., or other temperatures within or outside of these ranges.

The methods further include discharging from the mixer the composite that is formed. The discharged composite can have a liquid content of no more than 20% by weight, e.g., no more than 10% by weight based on the total weight of the composite, as outlined in the following equation:

Liquid content of composite %=100*[mass of liquid]/[mass of liquid+mass of dry composite]

In any of the methods disclosed herein, the discharged composite can have a liquid content of no more than 20% by weight, e.g., no more than 10% by weight based on total weight of the composite, such as no more than 9%, no more than 8%, no more than 7%, no more than 6%, no more than 5%, no more than 2%, or no more than 1% by weight, based on the total weight of the composite. This amount can range from 0.1% to 10%, from 0.5% to 9%, 0.5% to 7%, from 0.5% to 5%, from 0.5% to 3%, or from 0.5% to 2% by weight, based on the total weight of the composite discharged from the mixer at the end of the process.

In any of the methods disclosed herein, liquid content in the composite can be the measured as weight % of liquid present in the composite based on the total weight of the composite. Any number of instruments are known in the art for measuring liquid (e.g., water) content in rubber materials, such as a coulometric Karl Fischer titration system, or a moisture balance, e.g., from Mettler (Toledo International, Inc., Columbus, Ohio).

In any of the methods disclosed herein, while the discharged composite can have a liquid content of 20% or 10% by weight or less, there optionally may be liquid (e.g., water) present in the mixer which is not held in the composite that is discharged. This excess liquid is not part of the composite and is not part of any liquid content calculated for the composite.

In any of the methods disclosed herein, the total liquid content (or total water content or total moisture content) of the material charged into the mixer is higher than the liquid content of the composite discharged at the end of the process. For instance, the liquid content of the composite discharged can be lower than the liquid content of the material charged into the mixer by an amount of from 10% to 99.9% (wt. % vs wt. %), from 10% to 95%, or from 10% to 50%.

In a typical dry mixing process (solid elastomer and dry filler), it is often necessary to add certain additives; typical additives include anti-degradants, coupling agents, and one or more rubber chemicals to enable dispersion of filler into the elastomer. Rubber chemicals, as defined herein, include one or more of: processing aids (to provide ease in rubber mixing and processing, e.g. various oils and plasticizers, wax), activators (to activate the vulcanization process, e.g. zinc oxide and fatty acids), accelerators (to accelerate the vulcanization process, e.g. sulphenamides and thiazoles), vulcanizing agents (or curatives, to crosslink rubbers, e.g. sulfur, peroxides), and other rubber additives, such as, but not limited to, retarders, co-agents, peptizers, adhesion promoters, tackifiers, resins, flame retardants, colorants, and blowing agents. As an option, the rubber chemicals can comprise processing aids and activators. As another option, the one or more other rubber chemicals are selected from zinc oxide, fatty acids, zinc salts of fatty acids, wax, accelerators, resins, and processing oil.

However, the rubber chemicals can interfere with binding or interaction between filler and elastomer surfaces and have a negative impact on vulcanizate properties. It has been discovered that the use of a wet filler enables mixing in the absence of, or substantial absence of, such rubber chemicals.

Accordingly, as an option any method disclosed herein can comprise charging a mixer with at least the solid elastomer and wet filler, and, in one or more mixing steps, mixing the at least the solid elastomer and wet filler to form a mixture in the substantial absence of rubber chemicals at mixer temperatures controlled by at least one temperature-control means. As defined herein, “substantial absence” refers to a process wherein the charging step and the one or more mixing steps can be carried out in the presence of the one or more rubber chemicals in an amount less than 10% by weight of the total amount of rubber chemicals ultimately provided in a vulcanizate prepared from the composite, e.g., the cured composite, or the charging step and the one or more mixing steps can be carried out in the presence of the one or more rubber chemicals in an amount less than 5% or less than 1% by weight of the total amount of rubber chemicals ultimately in the composite. As it is optional to include the rubber chemicals in the composite, a suitable measure of determining “substantial absence” of the one or more rubber chemicals is to determine the amount targeted in the vulcanizate prepared from the composite, e.g., after curing the composite. Thus, a nominal amount of the one or more rubber chemicals may be added during said charging or mixing but not an amount sufficient to interfere with filler-elastomer interaction. As a further example of “substantial absence,” the charging and mixing can be carried out in the presence of the one or more rubber chemicals in an amount or loading of 5 phr or less, 4 phr or less, 3 phr or less, 2 phr or less, 1 phr or less, or 0.5 phr or less, 0.2 phr or less, 0.1 phr or less, based on the resulting vulcanizate.

Optionally the process further comprises adding anti-degradants during the charging or the mixing, i.e., during the one or more mixing steps. In any embodiment disclosed herein, as another option, after the mixing of at least the solid elastomer and wet filler has commenced and prior to the discharging step, the method can further include adding at least one anti-degradant to the mixer so that the at least one anti-degradant is mixed in with the solid elastomer and wet filler. As another option, the adding of the anti-degradant(s) can occur prior to the composite being formed and having a water content of 10 wt. % or less, or 5 wt. % or less.

The adding of the anti-degradant(s) can occur at any time prior to the discharging step, e.g., before or after the mixer reaches an indicated mixer temperature of 120° C. or higher. This indicated temperature can be measured by a temperature-measuring device within the mixing cavity. The indicated temperature of the mixer can be the same as or differ by 30° C. or less, or 20° C. or less, or 10° C. or less (or 5° C. or less or 3° C. or less or 2° C. or less) from the maximum temperature of the mixture or the composite achieved during the mixing stage (which can be determined by removing the composite from the mixer and inserting a thermocouple or other temperature measuring device into the composite). In this mixing method, as an option, the antidegradant and one or more rubber chemicals can be added to the mixer when the mixer reaches the temperature of 120° C. or higher. In other embodiments, the indicated temperature can range from 120° C. to 190° C., from 125° C. to 190° C., from 130° C. to 190° C., from 135° C. to 190° C., from 140° C. to 190° C., from 145° C. to 190° C., from 150° C. to 190° C., from 120° C. to 180° C., from 125° C. to 180° C., from 130° C. to 180° C., from 135° C. to 180° C., from 140° C. to 180° C., from 145° C. to 180° C., from 150° C. to 180° C., from 120° C. to 170° C., from 125° C. to 170° C., from 130° C. to 170° C., from 135° C. to 170° C., from 140° C. to 170° C., from 145° C. to 170° C., from 150° C. to 170° C., and the like. The one or more rubber chemicals can be added at the indicated temperature of 120° C. or higher; at this point the filler has been distributed and incorporated into the elastomer, and the addition of rubber chemicals is not expected to interfere with the interaction between filler and elastomer.

Examples of an anti-degradant that can be introduced is N-(1,3-dimethylbutyl)-N′-phenyl-p-phenylenediamine (6PPD), and others are described in other sections herein. The anti-degradant can be introduced in an amount ranging from 1% to 5%, from 0.5% to 2%, or from 0% to 3% by weight based on the weight of the composite that is formed. Anti-degradants added during the charging step or the mixing step may help prevent elastomer degradation during the mixing; however, due to the presence of the water in the mixture, the rate of degradation of the elastomer is lower compared to dry mix processes and the addition of anti-degradant can be delayed.

After the composite is formed and discharged, the method can include the further optional step of mixing the composite with additional elastomer to form a composite comprising a blend of elastomers. The “additional elastomer” or second elastomer can be additional natural rubber or can be an elastomer that is not natural rubber such as synthetic elastomers (e.g. styrene butadiene rubbers (SBR), polybutadiene (BR) and polyisoprene rubbers (IR), ethylene-propylene rubber (e.g., EPDM), isobutylene-based elastomers (e.g., butyl rubber), polychloroprene rubber (CR), nitrile rubbers (NBR), hydrogenated nitrile rubbers (HNBR), polysulfide rubbers, polyacrylate elastomers, fluoroelastomers, perfluoroelastomers, and silicone elastomers). Blends of two or more types of elastomers (blends of first and second elastomers), including blends of synthetic and natural rubbers or with two or more types of synthetic or natural rubber, may be used as well.

Different primary/secondary filler combinations can be achieved by any of the methods described herein, including:
CNS and secondary filler(s) by (e.g., by dry mixing processes);
wet CNS (e.g., wet extrudates, wet pellets) and filler;
CNS and at least one wet secondary filler (e.g., a wet secondary filler and non-wet secondary filler where the wet and non-wet fillers can be the same or different);
wet CNS and at least one wet secondary filler;
CNS-containing masterbatch combined (blended, compounded, mixed) with non-wet or at least one wet secondary filler) where the CNS-containing masterbatch can comprise any of the elastomers described herein, e.g., natural rubber, butadiene rubber; or
CNS-containing masterbatch combined (blended, compounded, mixed) with masterbatch containing at least one secondary filler (prepared with wet or non-wet fillers and/or with dry or wet mixing processes).

The CNS-containing masterbatch can optionally contain additional primary fillers as described herein.

In any method of producing an elastomer composite, the method can further include one or more of the following steps, after the initial step of combining the elastomer with filler:
one or more holding steps or further solidification or coagulation steps to develop further elasticity;
one or more dewatering or drying steps can be used to or further dry the composite to obtain a de-watered dried composite;
one or more extruding steps;
one or more calendaring steps;
one or more milling steps to obtain a milled composite;
one or more granulating steps;
one or more cutting steps;
one or more baling steps to obtain a baled product or mixture;
the baled mixture or product can be broken apart to form a granulated mixture;
one or more mixing or compounding steps to obtain a compounded composite; and/or
one or more sheeting steps.

As a further example, the following sequence of steps can occur and each step can be repeated any number of times (with the same or different settings), after the initial step of combining the elastomer with filler or after formation of the composite:
one or more holding steps or further coagulation steps to develop further elasticity
one or more cooling steps
dewatering or drying the composite (e.g., the elastomer composite exiting the reaction zone) to obtain a dewatered or further dried composite;
mixing or compounding the composite to obtain a compounded mixture;
milling the compounded mixture to obtain a milled mixture (e.g., roll milling);
granulating or mixing the milled mixture;
optionally baling the mixture after the granulating or mixing to obtain a baled mixture; or
optionally breaking apart the baled mixture and mixing.

In addition, or alternatively, the composite can be compounded with one or more antidegradants, rubber chemicals, and/or curing agents, and vulcanized to form a vulcanizate. Such vulcanized compounds can have one or more improved properties, such as one or more improved rubber properties, such as, but not limited to, an improved hysteresis, wear resistance and/or rolling resistance, e.g., in tires, or improved mechanical and/or tensile strength, or an improved tan delta and/or an improved tensile stress ratio, and the like.

As an example, in a compounding step, the ingredients, with the exception of the sulfur or other cross-linking agent and accelerator, are combined with the neat composite in a mixing apparatus (the non-curatives, e.g., rubber chemicals and/or antidegradants, are often pre-mixed and collectively termed “smalls”). The most common mixing apparatus is the internal mixer, e.g., the Banbury or Brabender mixer, but other mixers, such as continuous mixers (e.g., extruders), may also be employed. Thereafter, in a latter or second compounding step, the cross-linking agent, e.g., sulfur, and accelerator (if necessary) (collectively termed curatives) are added. The compounding step is frequently performed in the same type of apparatus as the mixing step but may be performed on a different type of mixer or extruder or on a roll mill. One of skill in the art will recognize that, once the curatives have been added, vulcanization will commence once the proper activation conditions for the cross-linking agent are achieved. Thus, where sulfur is used, the temperature during mixing is preferably maintained substantially below the cure temperature.

Also disclosed herein are methods of making a vulcanizate. The method can include the steps of at least curing a composite in the presence of at least one curing agent. Curing can be accomplished by applying heat, pressure, or both, as known in the art.

Other applicable methods of charging the mixer with the solid elastomer and wet filler, mixing and compounding processes, or steps after formation of the composite, are disclosed in PCT Application No. PCT/US2020/036168, filed Jun. 4, 2020, the disclosure of which is incorporated by reference herein.

The elastomer composite may be used to produce an elastomer or rubber containing product. The elastomeric composition or rubber composition can be for tire or tire parts. Various articles of manufacture, including tires and industrial products, may contain at least one component comprised of an elastomeric composition of this invention. For example, the elastomeric composition of this invention may be used in forming a composite with reinforcing material such as in the manufacture of tires, belts or hoses. Preferably, the composition of the present invention is in the form of a tire and more specially as a component of a tire, including, for example, one or more of the tire's tread, wirecoat, beadcoat, sidewall, apex, chafer and plycoat.

As an option, the elastomer composite may be used in or produced for use in various parts of a tire, for example, tire treads (such as on road or off-road tire treads), tire sidewalls, wire-skim for tires, and cushion gum for retread tires. Alternatively or in addition, elastomer composite may be used for hoses, seals, gaskets, anti-vibration articles, tracks, track pads for track-propelled equipment such as bulldozers, etc., engine mounts, earthquake stabilizers, mining equipment such as screens, mining equipment linings, conveyor belts, chute liners, slurry pump liners, mud pump components such as impellers, valve seats, valve bodies, piston hubs, piston rods, plungers, impellers for various applications such as mixing slurries and slurry pump impellers, grinding mill liners, cyclones and hydrocyclones, expansion joints, marine equipment such as linings for pumps (e.g., dredge pumps and outboard motor pumps), hoses (e.g., dredging hoses and outboard motor hoses), and other marine equipment, shaft seals for marine, oil, aerospace, and other applications, propeller shafts, linings for piping to convey, e.g., oil sands and/or tar sands, and other applications where abrasion resistance and/or enhanced dynamic properties are desired. The vulcanized elastomer composite may be used in rollers, cams, shafts, pipes, tread bushings for vehicles, or other applications where abrasion resistance and/or enhanced dynamic properties are desired. Traditional compounding techniques may be used to combine vulcanization agents and other additives known in the art, including the additives discussed above in connection with the dewatered product, with the dried elastomer composite, depending on the desired use.

As an example, CNS can be incorporated in elastomeric compositions for tire sidewall applications. It is known that silica in sidewall compositions can lead to a reduction in hysteresis loss of elastomeric compounds. However, silica-based elastomeric compositions are not electrically conductive. An appreciable amount of carbon black is often added to achieve the desirable level of electrical conductivity (e.g., 20-30 phr of N200 or N300 carbon black, and possibly more for N500 or N600 carbon black).

Sidewall elastomeric compositions can comprise silica (secondary filler comprising silica) and CNS (primary filler comprising CNS). The CNS dispersed in the elastomeric composition (e.g., rubber compound, vulcanizate) can lead to reduced electrical resistivity (improved electrical conductivity) at lower loadings compared to carbon black, e.g., 0.5 to 10 phr, 0.9 to 10 phr, 0.9 to 5 phr, 0.9 to 3 phr, 0.9 to 2 phr, 1 to 10 phr, 1 to 5 phr, 1 to 3 phr, or 1 to 2 phr. One skilled in the art can determine suitable loadings of silica and CNS to maintain processability and/or stiffness/hardness of the composition. Typical elastomers for sidewall compositions are blends of natural rubber and butadiene rubber where the amount of each rubber can range from, e.g., 40-60% by weight or 45-55% by weight, e.g., an NR:BR ratio ranging from 40:60 to 60:40 or from 45:55 to 55:45, such as ratios of about 50:50, about 40:60, about 45:55, about 55:45, or about 60:40. As an option, the sidewall composition can be a two-layer sidewall with the exterior layer being a silica-containing composition (or a silica composition) for reduced hysteresis and the interior layer comprising silica and CNS fillers, as described herein, to function as the electrical path. The elastomer can comprise conventional and functionalized polybutadienes (e.g., prepared from any catalyst).

In some situations, an initial CNS is broken into smaller CNS units or fragments. Except for their reduced sizes, these fragments generally share the properties of intact CNS and can be identified by electron microscopy and other techniques, as described above.

Also possible are changes in the initial nanostructure morphology of the CNS. For example, applied shear can break crosslinks between CNTs within a CNS to form CNTs that typically will be dispersed as individual CNTs in the elastomeric composition. It is found that structural features of branching and shared walls are retained for many of these CNTs, even after the crosslinks are removed. CNTs that are derived (prepared) from CNSs and retain structural features of CNT branching and shared walls are referred to herein as “fractured” CNTs. These species are capable of imparting improved interconnectivity (between CNT units), resulting in better conductivity at lower concentrations.

Thus, as an option, the elastomeric compositions of the present invention can include fractured CNTs. These fractured CNTs can readily be differentiated from ordinary carbon nanotubes through standard carbon nanotube analytical techniques, such as SEM, for example. It is further noted that not every CNT encountered needs to be branched and share common walls; rather it is a plurality of fractured CNTs, that, as a whole, will possess these features. As an example, at least 25% by number, at least 50% by number, at least 60% by number, at least 70% by number, at least 75% by number, or at least 85% by number of the CNTs present in an elastomeric composition can be fractured CNTs. This determination can be made by randomly evaluating at least 5 SEMs of the elastomeric composition and determining the percent of fractured CNTs compared to non-fractured CNTs present.

### EXAMPLES

The following tests were used to measure rubber properties on each of the vulcanizates:
Shore A hardness was measured according to ASTM D2240-05 with a Wallace Shore A Hardness Tester. The cured sample was conditioned for 24 hours at 45-55% relative humidity and at 21±2° C. prior to testing.
Tear strength measurements were conducted according to ASTM D624-00 with Die B samples having a pre-registered nick in the die. The cured samples were conditioned for 24 hours at 45-55% relative humidity and at 21±2° C. prior to testing.
Tensile stress at 50% elongation (M50) 100% elongation (M100), tensile stress at 300% elongation (M300), elongation at break, and tensile strength were evaluated by ASTM D412 (Test Method A, Die C) at 23° C., 50% relative humidity and at crosshead speed of 500 mm/min. Extensometers were used to measure tensile strain.
Max tan δ was measured with an ARES-G2 rheometer (Manufacturer: TA Instruments) using 8 mm diameter parallel plate geometry in torsional mode. The vulcanizate specimen diameter size was 8 mm diameter and about 2 mm in thickness. The rheometer was operated at a constant temperature of 60° C. and at constant frequency of 10 Hz. Strain sweeps were run from 0.1-68% strain amplitude. Measurements were taken at ten points per decade and the maximum measured tan δ (“max tan δ”) was recorded, also referred to as “tan δ” unless specified otherwise.
Volume resistivity (Ohm-cm) measurements were conducted on 2 mm thick rubber plaques cut from sheets with a 2″×5″ resistivity die. Both ends of the sheet (˜5″ apart) were painted with Conductive Silver Paint 187 (Electron Microscopy Sciences) on both sides of the plaque and dried overnight. Resistivity clamps were attached to the painted edges and voltage was measured with a Wavetek® meter. For resistance readings beyond 2000 M Ohms, measurements were conducted with a Dr. Kamphausen Milli-TO 2 meter.

### Example 1

This section describes the preparation of composites and corresponding vulcanizates comprising a fluoroelastomer (FKM) with CNS alone or carbon black alone or both CNS and carbon black as fillers. The CNS was manufactured by Applied Nanostructured Solutions LLC, a wholly owned subsidiary of Cabot Corporation. The ASTM grade N990 carbon black, provided in powder form, was obtained from Cancarb with the trade name of Thermax®. The FKM compound was Viton® GF600S FKM from Chemours. The compound formulation (phr, part per hundred rubber) is shown in Table 1.

TABLE 1

| Ingredient | Loading (PHR) |
|---|---|
| Viton ® GF600S FKM | 100 |
| N990 carbon black | 0, 30, 60 |
| CNS | 0.5, 1, 2, 3, 5 |
| Zinc oxide | 3 |
| DIAK 7 | 3 |
| Luperox ® 101XL45 | 3 |

Compound mixing: Elastomer compounding was carried out in 3 stages. The first stage used an Intermesh mixer with 1.77-liter mixing chamber to mix the filler(s) and zinc oxide with the elastomer. The second stage used the same mixer to masticate compounds produced in the first stage. The final stage used a Brabender mixer to mix the stage 2 compounds with curatives (Luperox® 101XL45 and DIAK 7).

Table 2 summarizes the mechanical properties of the elastomeric compounds. Table 3 summarizes the volume resistivity and Mooney viscosity of the elastomeric compounds. As shown in the Tables, the elastomeric compounds that had CNS as the filler alone or with carbon black were more efficient in reinforcing the elastomeric compounds. For instance, the elastomeric compound that had only 2 phr CNS (#E1_4 in Table 2) has a much higher M50 than the elastomeric compound having 60 phr N990 carbon black at both room temperature and 200° C. And the elastomeric compound having 0.5 phr CNS and 30 phr N990 carbon black (#E1_7) had nearly 80% higher M50, 45% higher tensile strength, and 38% higher tear strength than the elastomeric compound having 30 phr N990 carbon black (#E1_1) at room temperature, while the Mooney viscosities of these two compounds are similar to each other, as shown in Table 3. Further, as shown in the Tables, when the filler used was CNS, this filler was also more efficient in lowering the volume resistivity of the elastomeric compounds compared to the elastomeric compounds that used carbon black as the filler. With only 2 phr of CNS, the volume resistivity of the elastomeric compound was 3 orders of magnitude lower than the volume resistivity of the elastomeric compound with 60 phr N990 carbon black. And the viscosity of the elastomeric compound with 1 phr CNS was much lower than the viscosity of the elastomeric compound with 60 phr N990 carbon black.

For some of the properties measured in some of the samples, as set forth in Table 2 (Comparison of tensile properties and tear strength) and Table 3 (Comparison of volume resistivity and Mooney viscosity), the Impact Number for CNS in each of samples E1_8, E1_9, and E1_10 (and for every property measured) was over E1_7 and typically much higher. And, the Impact Number for the carbon black in each of samples 8, 9, and 10 (and for every property measured) was less than 1. In the Tables, N/A means ‘not measured’ and “RT” is room temperature.

TABLE 2

| | | | Tensile | Tear | | Tensile | Tear |
|---|---|---|---|---|---|---|---|
| | Additives | M50 | strength | strength | M50 at | strength at | strength at |
| Compound | and loading | at RT | at RT | at RT | 200° C. | 200° C. | 200° C. |
| Number | (phr) | (Mpa) | (Mpa) | (KN/m) | (Mpa) | (Mpa) | (KN/m) |
| E1_1 | 30 PHR | 3.31 | 19.53 | 35.21 | 2.82 | 3.12 | 6.83 |
| | N990 | | | | | | |
| E1_2 | 60 PHR | 8.16 | 22.12 | 44.75 | 4.94 | 5.70 | 11.21 |
| | N990 | | | | | | |
| E1_3 | 1 PHR CNS | 2.82 | 13.23 | 43.37 | 2.59 | 3.18 | N/A |
| E1_4 | 2 PHR CNS | 11.30 | 16.45 | 75.98 | 5.20 | 5.60 | N/A |
| E1_5 | 3 PHR CNS | 13.76 | 18.57 | 101.61 | N/A | 6.76 | 20.31 |
| E1_6 | 5 PHR CNS | 27.13 | 28.42 | 151.61 | 6.46 | 7.25 | 47.98 |
| E1_7 | 0.5 PHR | 5.94 | 21.78 | 48.76 | 3.93 | 4.92 | 10.33 |
| | CNS + 30 | | | | | | |
| | PHR N990 | | | | | | |
| E1_8 | 1 PHR | 8.03 | 22.94 | 54.34 | 4.14 | 4.95 | 12.78 |
| | CNS + 30 | | | | | | |
| | PHR N990 | | | | | | |
| E1_9 | 2 PHR | 13.38 | 23.47 | 74.33 | 6.53 | 7.06 | 19.44 |
| | CNS + 30 | | | | | | |
| | PHR N990 | | | | | | |
| E1_10 | 3 PHR | 19.93 | 23.59 | 89.13 | N/A | 8.45 | 28.37 |
| | CNS + 30 | | | | | | |
| | PHR N990 | | | | | | |

TABLE 3

| | | Volume | |
|---|---|---|---|
| | Additives and | resistivity | Mooney viscosity, |
| Compound# | loading (phr) | (ohm · cm) | ML(1 + 10)@121° C. |
| E1_1 | 30 PHR N990 | 1.07E+10 | 71.15 |
| E1_2 | 60 PHR N990 | 1.76E+04 | 95.4 |
| E1_3 | 1 PHR CNS | 3.09E+06 | 55.28 |
| E1_4 | 2 PHR CNS | 1.52E+01 | 59.43 |
| E1_5 | 3 PHR CNS | 1.33 | 62.29 |
| E1_6 | 5 PHR CNS | 0.4 | 74.43 |
| E1_7 | 0.5 PHR CNS + | 5.94E+03 | 72.98 |
| | 30 PHR N990 | | |
| E1_8 | 1 PHR CNS + | 8.01E+03 | 74.87 |
| | 30 PHR N990 | | |
| E1_9 | 2 PHR CNS + | 6.5 | 79.48 |
| | 30 PHR N990 | | |
| E1_10 | 3 PHR CNS + | 1.58 | 85.49 |
| | 30 PHR N990 | | |

### Example 2

Natural rubber compounds with CNS. Natural rubber compounds with CNS were prepared using a masterbatch letdown process. First, a natural rubber masterbatch was produced by mixing 8 PHR of CNS pellets with natural rubber (SMR20) using a Banbury mixer with 1.6 liter mixing chamber through a 2 stage mixing process. Table 4 (Conditions for CNS/natural rubber masterbatch mixing) and Table 5 (Mixing sequence for producing CNS/natural rubber masterbatch) show the mixing conditions for this masterbatch. In Table 5, temperature was used to determine when to conduct the next step (time was not used).

TABLE 4

| | | |
|---|---|---|
| Fill factor | 70% | (vol) |
| Walls Temperature: | 50° | C. |
| Rotors Temperature: | 50° | C. |
| Start Temperature: | 50° | C. |
| Rotor speed | 80 | RPM |
| Ram Pressure: | 2.8 | bar |

TABLE 5

| | Step | Step Time | | | |
|---|---|---|---|---|---|
| Step | Time | Non-Cumulative | Step | | |
| No. | (sec) | (sec) | Temperature | | Step Description |
| 1 | 0 | 0 | 50° | C. | Add half of natural |
| | | | | | rubber |
| 2 | 30 | 30 | | | Add CNS slowly. |
| 3 | | | 130° | C. | Sweep |
| 4 | | | 140° | C. | Add Antioxidant 12 |
| 5 | | | 145° | C. | Sweep |
| 6 | | | 160° | C. | Dump |

The masterbatch was mixed with new natural rubber and other additives using a 3-stage mixing process. In the first stage, the masterbatch, natural rubber, N375 carbon black, zinc oxide, 6PPD, antioxidant DQ, and steric acid were mixed in a Banbury mixer with 1.6 liter mixing chamber and then formed into sheets using a two-roll mill. Table 6 (Stage 1 compound formulation, phr) shows the formulation of compounds produced in stage 1. Stage 1 mixing conditions are shown in Table 7 (Conditions for stage 1 compounding) and Table 8 (Mixing sequence for stage 1 compounding). In the second stage, the compounds from the first stage were masticated in a Banbury mixer and formed into sheets using a two-roll mill. Stage 2 mixing conditions are shown in Table 9 (Conditions for stage 2 compounding) and Table 10 (Mixing sequence for stage 2 compounding). In the third stage, the compounds from stage 2 were mixed with sulfur and BBTS in a Banbury mixer and then formed into sheets using a 2-roll mill. Table 11 (Stage 3 compound formulation, phr) shows the formulation of compounds in stage 3. Mixing conditions of stage 3 are shown in Table 12 (Conditions for stage 3 compounding) and Table 13 (Mixing sequence for stage 3 compounding). Compounds after the three-stage mixing process were cured at 150° C. Table 14 summarizes the loading of CNS and carbon blacks in compounds and properties of compounds.

TABLE 6

| | Compound# | | | | | | | |
|---|---|---|---|---|---|---|---|---|
| | E2_1 | E2_2 | E2_3 | E2_4 | E2_5 | E2_6 | E2_7 | E2_8 |
| SMR20 | 93.75 | 87.50 | 75.00 | 100 | 100 | 100 | 87.50 | 75.00 |
| CNS masterbatch | 6.75 | 13.50 | 27.00 | | | | 13.50 | 27.00 |
| N375 carbon black | | 0 | 0 | 30 | 40 | 50 | 40 | 40 |
| 6PPD | 1.50 | 1.50 | 1.50 | 1.50 | 1.50 | 1.50 | 1.50 | 1.50 |
| Antioxidant DQ pellets | .50 | .50 | .50 | .50 | .50 | .50 | .50 | .50 |
| Zinc oxide | 3.00 | 3.00 | 3.00 | 3.00 | 3.00 | 3.00 | 3.00 | 3.00 |
| Steric acid | 2.00 | 2.00 | 2.00 | 2.00 | 2.00 | 2.00 | 2.00 | 2.00 |
| Sulfur | 1.90 | 1.90 | 1.90 | 1.90 | 1.90 | 1.90 | 1.90 | 1.90 |
| BBTS | 1.40 | 1.40 | 1.40 | 1.40 | 1.40 | 1.40 | 1.40 | 1.40 |

TABLE 7

| | | |
|---|---|---|
| Fill factor | 70% | (vol) |
| Walls Temperature: | 50° | C. |
| Rotors Temperature: | 50° | C. |
| Start Temperature: | 50° | C. |
| Rotor speed | 80 | RPM |
| Ram Pressure: | 2.8 | bar |

TABLE 8

| | Step | Step Time | Step | |
|---|---|---|---|---|
| Step | Time | Non-Cumulative | Temperature | |
| No. | (s) | (s) | (° C.) | Step Description |
| 1 | 0 | 0 | 50° C. | Add Polymer and/or |
| | | | | masterbatch |
| 2 | 30 | 30 | | Add ⅔ carbon black if |
| | | | | there is carbon black |
| | | | | in formulation |
| 3 | 90 | 60 | 125° C. | Sweep and add |
| | | | | remaining carbon black |
| 4 | 120 | 30 | | Sweep |
| 5 | 180 | 60 | 140 | Add Oil and Smalls |
| 6 | 210 | 30 | 145 | Scrape/Sweep |
| 7 | 300 | 90 | 160 | Dump |

TABLE 9

| | | |
|---|---|---|
| Fill factor | 70% | (vol) |
| Walls Temperature: | 50° | C. |
| Rotors Temperature: | 50° | C. |
| Start Temperature: | 50° | C. |
| Rotor speed | 80 | RPM |
| Ram Pressure: | 2.8 | bar |

TABLE 11

| | Compound# | | | | | | | |
|---|---|---|---|---|---|---|---|---|
| | E2_1 | E2_2 | E2_3 | E2_4 | E2_5 | E2_6 | E2_7 | E2_8 |
| Stage 2 compound | 107.5 | 108 | 109 | 137 | 147 | 157 | 148 | 149 |
| Sulfur | 1.90 | 1.90 | 1.90 | 1.90 | 1.90 | 1.90 | 1.90 | 1.90 |
| Akrochem Accelerator | 1.40 | 1.40 | 1.40 | 1.40 | 1.40 | 1.40 | 1.40 | 1.40 |
| BBTS powder | | | | | | | | |

TABLE 10

| | Step | Step Time | Step | |
|---|---|---|---|---|
| Step | Time | Non-Cumulative | Temperature | |
| No. | (s) | (s) | °(C.) | Step Description |
| 1 | 0 | 0 | 50 | Add Stage 1 |
| | | | | Masterbatch |
| 4 | 180 | 90 | 160 | Dump at 180 s or |
| | | | | 160° C., whichever |
| | | | | reaches first. |

TABLE 12

| | | |
|---|---|---|
| Fill factor | 65% | (vol) |
| Walls Temperature: | 50° | C. |
| Rotors Temperature: | 50° | C. |
| Start Temperature: | 50° | C. |
| Rotor speed | 80 | RPM |
| Ram Pressure: | 2.8 | bar |

TABLE 13

| | Step | Step Time | Step | |
|---|---|---|---|---|
| Step | Time | Non-cumulative | Temperature | |
| No. | (s) | (s) | (° C.) | Step Description |
| 1 | 0 | 0 | 50 | Add ½ stage 2 |
| | | | | Masterbatch/curatives/ |
| | | | | remaining masterbatch |
| 2 | 30 | 30 | | Sweep |
| 3 | 90 | 60 | | Dump |

TABLE 14

| | | | | | | Tear | | Mooney |
|---|---|---|---|---|---|---|---|---|
| | CB | CNS | | Tensile | | strength, | Volume | viscosity, |
| | loading | loading | Elongation | strength | M100 | die B | resistivity | ML(1 + 4)@ |
| Compound# | (PHR) | (PHR) | (%) | (MPa) | (MPa) | (KN/m) | (ohm · cm) | 100 C. |
| E2_1 | 0 | 0.5 | 654 | 25.52 | 1.62 | 63.5 | 1.60E+09 | 34.2 |
| E2_2 | 0 | 1 | 614 | 26.42 | 2.67 | 74.7 | 1.57E+06 | 33.0 |
| E2_3 | 0 | 2 | 604 | 27.69 | 3.56 | 74.4 | 2.72E+07 | 34.9 |
| E2_4 | 30 | 0 | 562 | 31.69 | 2.09 | 118.1 | 3.57E+06 | 46.6 |
| E2_5 | 40 | 0 | 514 | 30.74 | 2.64 | 135.5 | 1.56E+04 | 52.3 |
| E2_6 | 50 | 0 | 496 | 31.13 | 3.49 | 159.7 | 1.60E+03 | 61.5 |
| E2_7 | 40 | 1 | 496 | 30.53 | 5.04 | 149.1 | 9.68E+00 | 55.0 |
| E2_8 | 40 | 2 | 453 | 31.06 | 8.11 | 142.3 | 1.68E+00 | 59.3 |

### Example 3: SBR Compound with Silica and CNS

Compounding of solution SBR compounds was performed in a 3-stage mixing process using an Intermesh mixer with 1.77-liter mixing chamber. In the first stage, ingredients shown in Table 15 (Ingredients mixed in stage 1 mixing) were mixed according to the mixing conditions/sequences shown in Tables 16 (Conditions for stage 1 and stage 2 mixing) and 17. The resulting compounds then went through a two-roll mill to form a sheet. In the stage 2 mixing, the compounds produced in stage 1 were masticated according to the mixing conditions/sequences shown in Table 17 (Stage 1 mixing sequence) and Table 18 (Stage 2 mixing sequence) without additional ingredients. The resulting compounds then went through a two-roll mill to form a sheet. In stage 3 mixing, the compounds produced in stage 2 were mixed with accelerators and sulfur according to the loading levels listed in Table 19 (Ingredients mixed in stage 3 compounding). The mixing conditions and sequences were shown in Table 20 (Conditions for stage 3 mixing) and Table 21 (Stage 3 mixing sequence) respectively. The resulting compounds then went through a two-roll mill to form a sheet. The resulting compounds were cured at 160° C. in a hydraulic press, the curing time for the specimen with a thickness of less than 2 mm was 14 minutes and the curing time for the specimen equal or thicker than 2 mm was 24 minutes. Table 22 summarizes the properties of compounds in this example.

TABLE 15

| | | E3_1 | E3_2 | E3_3 | E3_4 |
|---|---|---|---|---|---|
| Ingredients | Brand/grade | (phr) | (phr) | (phr) | (phr) |
| Oil extended | BUNA ® VSL | 96.25 | 96.25 | 96.25 | 96.25 |
| solution SBR | 4526-2 HM sSBR | | | | |
| (sSBR) | | | | | |
| Butadiene rubber | Buna ® CB 24 BR | 30.00 | 30.00 | 30.00 | 30.00 |
| (BR) | | | | | |
| Precipitated | Zeosil ® 1165MP | 78.00 | 78.00 | 78.00 | 58.00 |
| Silica | silica | | | | |
| Carbon black | Vulcan ® 7H CB | 2.00 | 2.00 | 2.00 | 2.00 |
| CNS | ANS (Cabot) | | 2.00 | 3.00 | 3.00 |
| Silane coupling | Si 69 ® organosilane | 6.24 | 6.24 | 6.24 | 4.64 |
| agent | | | | | |
| Processing Oil | Vivatec ® 500 oil | 1.75 | 1.75 | 1.75 | 1.75 |
| Zinc Oxide | Akrochem RGT-M | 3.50 | 3.50 | 3.50 | 3.50 |
| Stearic Acid | | 2.00 | 2.00 | 2.00 | 2.00 |
| Wax | Akrowax ™ 5031 | 1.00 | 1.00 | 1.00 | 1.00 |
| | Beads | | | | |
| 6PPD | | 2.00 | 2.00 | 2.00 | 2.00 |

TABLE 16

| | | |
|---|---|---|
| Fill factor | 67% | (vol) |
| Walls Temperature: | 70° | C. |
| Rotors Temperature: | 70° | C. |
| Start Temperature: | 70° | C. |
| Rotor speed | 80 | RPM |
| Ram Pressure: | 2.4 | bar |

TABLE 17

| | Step | Step Time | Step | |
|---|---|---|---|---|
| Step | Time | Non-Cumulative | Temperature | |
| No. | (s) | (s) | (° C.) | Step Description |
| 1 | 0 | 0 | 70° C. | Add all rubbers |
| 2 | 60 | 60 | | Add ½ silica and all silane |
| | | | | coupling agent |
| 3 | 120 | 60 | | Add remaining silica, CB/CNS |
| | | | | pellets and other ingredients |
| | | | | except oil. |
| 4 | 200 | 80 | | Sweep and add oils, increase |
| | | | | roller speed to 100 RPM |
| 5 | | | 140° C. | When ram is fully down, hold |
| | | | | Temp at 140 C. for 105 s |
| 6 | | 105 | | Dump after holding for 105 s |

TABLE 18

| | Step | Step Time | Step | |
|---|---|---|---|---|
| Step | Time | Non-Cumulative | Temperature | |
| No. | (s) | (s) | (° C.) | Step Description |
| 1 | 0 | 0 | 70° C. | Add stage 1 compounds |
| 2 | 60 | 60 | | Sweep |
| 3 | | | 135° C. | Hold at 135° C. for 75 s |
| 4 | | 75 | | Dump after holding for 75 s |

TABLE 19

| | | E3_1 | E3_2 | E3_3 | E3_4 |
|---|---|---|---|---|---|
| Ingredients | Brand/grade | (phr) | (phr) | (phr) | (phr) |
| Compounds | | 222.74 | 224.74 | 225.74 | 204.14 |
| from stage 2 | | | | | |
| Accelerator 1 | Akrochem DPG | 2.10 | 2.10 | 2.10 | 2.10 |
| Accelerator 2 | ACCELERATOR | 2.00 | 2.00 | 2.00 | 2.00 |
| | CBTS | | | | |
| Sulfur | Akrochem | 1.60 | 1.60 | 1.60 | 1.60 |
| | rubbermakers | | | | |
| | sulfur | | | | |

TABLE 20

| Fill factor | 62% (vol) | |
|---|---|---|
| Walls Temperature: | 50° | C. |
| Rotors Temperature: | 50° | C. |
| Start Temperature: | 50° | C. |
| Rotor speed | 60 | RPM |
| Ram Pressure: | 2.4 | bar |

TABLE 21

| | | Step Time | Step | |
|---|---|---|---|---|
| Step | Step Time | Non-Cumulative | Temperature | |
| No. | (s) | (s) | (° C.) | Step Description |
| 1 | 0 | 0 | 50° C. | Add half of stage 2 compounds, |
| | | | | followed by accelerators and |
| | | | | sulfur and then the rest of |
| | | | | stage 2 compounds |
| 2 | 30 | 30 | | Sweep |
| 3 | 90 | 60 | | Dump at 90 s |

TABLE 22

| | Compound | Compound | Compound | Compound |
|---|---|---|---|---|
| Properties | E3_1 | E3_2 | E3_3 | E3_4 |
| CNS loading (PHR) | 0 | 2 | 3 | 3 |
| Silica loading (PHR) | 78 | 78 | 78 | 58 |
| Tensile strength (MPa) | 20.85 | 22.23 | 22.58 | 19.45 |
| Elongation at break (%) | 402 | 396 | 386 | 407 |
| M100 (MPa) | 2.57 | 4.07 | 5.13 | 4.08 |
| M300 (MPa) | 13.56 | 16.19 | 16.66 | 13.24 |
| Tear strength, die B | 47.6 | 57.0 | 70.3 | 71.5 |
| (N/mm) | | | | |
| G' at 10% strain | 2.19 | 2.56 | 2.63 | 2.00 |
| Maximum tan δ | 0.149 | 0.176 | 0.191 | 0.158 |
| Volume resistivity | 1.76E+9 | 5.91E+7 | 4.17E+03 | 7.44E+03 |
| (ohm · cm) | | | | |

### Example 4

This Example describes the preparation of a composite from CNS wet pellets and wet extrudates, as well as the corresponding vulcanizates. In this Example, initially a masterbatch of CNS in elastomer was formed, followed by mixing this masterbatch with a second elastomer and a blend of silica/carbon black.

Water content in the discharged composite was measured using a moisture balance (Model: HE53, Manufacturer: Mettler Toledo NA, Ohio). The composite was sliced into small pieces (size: length, width, height<5 mm) and 2 to 2.5 g of material was placed on a disposable aluminum disc/plate which was placed inside the moisture balance. Weight loss was recorded for 30 mins at 125° C. At the end of 30 mins, moisture content for the composite was recorded as:

$$moisture content of composite = ( \frac{initial weight - final weight}{initial weight} ) * 100.$$

Preparation of CNS wet pellets. CNS dry pellets (100 g; Applied Nanostructured Solutions LLC, a wholly owned subsidiary of Cabot Corporation) and water (900 g) were placed in a Nalgene® wide mouth plastic bottle. The bottle was sealed tightly with a plastic cap and placed on a drum roller. This mixture was rolled for two hours at a roller speed of 38 rpm to form the CNS wet pellets with 90% water content by weight.

Preparation of CNS wet extrudates. CNS wet extrudates are intermediate products in the CNS production process, which was described in U.S. Pat. No. 8,999,453 B2, the disclosure of which is incorporated by reference herein. A chemical vapor deposition (CVD)-based process for growing carbon nanotubes was used to continuously grow infused carbon nanotubes on a glass fiber. After the CVD growth process, the resulting CNS flakes were blown off the catalyzed glass fiber substrate using compressed air and a high flow nozzle trained on the glass fiber within the harvester machine. The dislodged flakes were conveyed pneumatically to a pelletization area. The flakes were separated from the conveying air using either a cyclone or filter dust collector and delivered into a hopper or mixer where they were sprayed and blended with a binder solution. The binder solution was an aqueous solution of polyethylene glycol which was prepared by dissolving 8 grams of pure polyethylene glycol in 35 gallons of water. The resulting mixture of CNS flakes and binder solution, or “wet flakes,” was then extruded through circular openings in a die with a single-screw or twin-screw pelletizing extruder to form wet extrudates having a water content of 92 wt. %.

Preparation of CNS Masterbatch. The formulations for the CNS masterbatch are shown in Table 23. The elastomer used was oil-extended s-styrene butadiene rubber (“OESSBR”; BUNA® VSL 4526-2 HM s-SBR, Lanxess, Germany). The antioxidant was Antioxidant 12 (Akrochem, Akron, Ohio).

TABLE 23

| | MB 1-1 | MB 1-2 |
|---|---|---|
| Ingredients | (phr) | (phr) |
| OESSBR | 137.5 | 137.5 |
| CNS wet pellets | 13.75 | |
| CNS wet extrudates | | 13.75 |
| Antioxidant | 1.375 | 1.375 |

The masterbatch was prepared via 2-stage mixing. Mixing was performed with a BR-1600 Banbury® mixer (“BR1600”; Manufacturer: Farrell) with a ram pressure of 2.8 bar. The BR1600 mixer was operated with two 2-wing, tangential rotors (2WL), providing a capacity of 1.6 L. The first stage mixing protocol is provided in Table 24. Conditions for first stage mixing were: TCU temperature=105° C., fill factor=70%, rotor speed=105 rpm, ram pressure=2.8 bar.

TABLE 24

| | |
|---|---|
| Time or | |
| Temperature | Description |

| | | |
|---|---|---|
| 0 | s | Add half of the rubber |
| 30 | s | Reduce rotor speed to 40 rpm and ram |
| | | pressure to 1.5 bar. Then add CNS. |
| | | After all CNS is added, lower ram to |
| | | down position. |
| | | Once ram is fully seated and CNS fully |
| | | ingested, raise ram and add remaining |
| | | rubber. Increase ram pressure to 2.8 bar. |
| | | And lower ram down. Once ram is fully |
| | | seated, increase rotor speed to 105 rpm. |
| 130° | C. | Sweep |
| 140° | C. | Add antioxidant |
| 160° | C. | Dump |

The moisture content of the resulting composites was 0.21 wt. % for MB-1-1 and 0.36 wt. % for MB1-2. The resulting compounds were passed through a two-roll mill operated at 50° C. and about 37 rpm, followed by six end-rolls with a nip gap of about 5 mm, with a rest time before next stage of mixing of at least 3 hours to form a sheet. The protocol for second stage mixing is shown in Table 25. Mixing conditions were: fill factor=70%, TCU temperature=80° C., rotor speed=80 rpm, ram pressure=2.8 bar.

TABLE 25

| | |
|---|---|
| Time (s) | Description |

| | | |
|---|---|---|
| 0 | s | Add stage 1 masterbatch |
| 300 | s | Dump. Adjust rotor speed to maintain |
| | | mixing temperature below 150° C. |

The resulting compounds were passed through a two-roll mill operated at 50° C. and about 37 rpm, followed by six end-rolls with a nip gap about 5 mm.

Preparation of CNS rubber compounds. Rubber compounds were formed via 3-stage mixing. In the first stage, the CNS masterbatches, MB 1-1 and MB 1-2 were combined with oil-extended s-SBR (OESSBR), butadiene rubber (“BR”; Buna® CB 24 butadiene rubber, Lanxess, Germany), precipitated silica (ZEOSIL® Z1165 MP precipitated silica, Solvay USA Inc., Cranbury, N.J), and carbon black (Vulcan® 7H carbon black, Cabot Corporation) in the amounts shown in Table 26. The silane coupling agent used was Si-69 silane coupling agent (“Si69”; Evonik Industries). The antioxidant used was N-(1,3-dimethylbutyl)-N′-phenyl-p-phenylenediamine (6PPD). Rubber chemicals used were Vivatec 500 processing oil (H&R Group, Inc.), Akrowax™ 5031 wax beads (Akrochem, Akron, Ohio). The formulations for the first stage compounding are shown in Table 26.

TABLE 26

| | Ex. 4_1 | Ex. 4_2 | Ex. 4_3 | Ex. 4_4 |
|---|---|---|---|---|
| Ingredients | (phr) | (phr) | (phr) | (phr) |
| OESSBR | 96.25 | 96.25 | 66.25 | 66.25 |
| BR | 30 | 30 | 30 | 30 |
| silica | 78 | 58 | 58 | 58 |
| CB | 2 | 2 | 2 | 2 |
| MB 1-1 | | | 33.3 | |
| MB 1-2 | | | | 33.3 |
| Si-69 | 6.24 | 4.64 | 4.64 | 4.64 |
| Processing Oil | 1.75 | 1.75 | 1.75 | 1.75 |
| Zinc Oxide | 3.5 | 3.5 | 3.5 | 3.5 |
| Stearic Acid | 2 | 2 | 2 | 2 |
| Wax | 1 | 1 | 1 | 1 |
| 6PPD | 2 | 2 | 2 | 2 |

All mixing was performed with an intermesh mixer with a 1.77 L mixing chamber (Technolab Intermix IM 1.5E, Farrel Ltd.). Conditions for stage 1 and stage 2 compounding were: fill factor=67%, TCU temperature=70° C., rotor speed=80 rpm, ram pressure=2.4 bar. Protocols for Stage 1 and Stage 2 compounding are shown in Tables 27 and 28, respectively. Time refers to cumulative time.

TABLE 27

| | |
|---|---|
| Time or | |
| Temperature | Description |

| | | |
|---|---|---|
| 0 | s | Add rubber and optional masterbatch |
| 60 | s | Add ½ silica and all silane coupling agent |
| 120 | s | Add remaining silica, CB, and other |
| | | ingredients except oil |
| 200 | s | Sweep and add oils, increase rotor speed |
| | | to 100 rpm |
| 160° | C. | When ram is fully down, hold temperature |
| | | at 160° C. for 105 seconds by adjusting |
| | | rotor speed. Dump. |

TABLE 28

| | |
|---|---|
| Time or | |
| Temperature | Description |

| | | |
|---|---|---|
| 0 | s | Add stage 1 composite |
| 60 | s | Sweep |
| 140° | C. | Hold at 140° C. for 75 s. Dump |

The resulting stage 2 compounds were passed through a two-roll mill operated at 50° C. and about 37 rpm, followed by six end-rolls with a nip gap about 5 mm. In stage 3 compounding, curatives and accelerators were added as shown in Table 29 (N,N′-diphenyl guanidine, “DPG” powder; N-cyclohexyl-2-benzothiazole sulfenamide, “CBS” Accelerator CBTS; both available from Akrochem). Protocols for stage 3 mixing are shown in Table 30. Mixing conditions were: 62%, TCU temperature=50° C., rotor speed=60 rpm, ram pressure=2.4 bar. Time refers to cumulative time.

TABLE 29

| | Ex. 4_1 | Ex. 4_2 | Ex. 4_3 | Ex. 4_4 |
|---|---|---|---|---|
| Ingredients | (phr) | (phr) | (phr) | (phr) |
| stage 2 | 222.74 | 204.44 | 204.44 | 204.44 |
| composites | | | | |
| DPG | 2.1 | 2.10 | 2.10 | 2.10 |
| CBTS | 2.00 | 2.00 | 2.00 | 2.00 |
| Sulfur | 1.60 | 1.60 | 1.60 | 1.60 |

TABLE 30

| Time (s) | Description |
|---|---|
| 0 | Add half of stage 2 composites, followed by accelerators |
| | and sulfur and then the rest of stage 2 composites |
| 30 | Sweep |
| 90 | Dump |

The resulting compounds were passed through a two-roll mill to form sheets. The compounds were then cured at 160° C. in a hydraulic press with curing times (in minutes) are shown in Table 31. Properties of the resulting compounds are shown in Table 32.

TABLE 31

| Compound | Ex 4_1 | Ex. 4_2 | Ex. 4_3 | Ex. 4_4 |
|---|---|---|---|---|
| sheet thickness equal | 12 | 11 | 12 | 12 |
| or less than 2 mm | | | | |
| sheet thickness | 22 | 21 | 22 | 22 |
| more than 2 mm | | | | |

TABLE 32

| Properties | Ex. 4_1 | Ex. 4_2 | Ex. 4_3 | Ex. 4_4 |
|---|---|---|---|---|
| CNS loading (PHR) | 0 | 0 | 3 | 3 |
| Silica loading (PHR) | 78 | 58 | 58 | 58 |
| Shore A hardness (RT) | 61 | 55 | 64 | 70 |
| Tensile strength (MPa) | 19.68 | 17.39 | 20.39 | 18.24 |
| Tear strength, die B | 41.6 | 51.7 | 64.7 | 52.6 |
| (N/mm) | | | | |
| Maximum tan δ | 0.123 | 0.112 | 0.139 | 0.134 |
| Volume resistivity | 3.13 × 10⁹ | 1.74 × 10⁹ | 3.84 × 10⁴ | 1.08 × 10⁴ |
| (Ohm · cm) | | | | |

Ex. 41 and Ex. 4_2 are controls containing no CNS filler. From the data of Table 32, it can be seen that the compounds with 58 phr of silica and CNS (Ex. 4_3 and Ex. 4_4), exhibit a significant reduction in volume resistivity compared to compounds without CNS (Ex. 41 and Ex. 4_2). Properties such as Shore A hardness, tensile strength, and tear strength were also increased for compounds with CNS (Ex. 43 and Ex. 4_4) compared to the compound without CNS having similar silica loading (Ex. 4_2).

### Example 5

This Example describes the preparation of a silica-containing composite that also contains CNS wet extrudates as well as the corresponding vulcanizates. CNS wet extrudates were prepared according to the method disclosed in Example 4.

Natural rubber compounds containing CNS, precipitated silica, and carbon black were prepared via a 3-stage mixing process. Mixing was performed with the BR1600 at a ram pressure of 2.8 bar. The solid elastomer used was standard grade RSS3 natural rubber (Hokson Rubber, Malaysia). Technical descriptions of these natural rubbers are widely available, such as in Rubber World Magazine's Blue Book published by Lippincott and Peto, Inc. (Akron, Ohio, USA). ZEOSIL® Z1165 MP precipitated silica (“Z1165MP”), Solvay USA Inc., Cranbury, N.J, and ASTM grade N330 carbon black (Orion Engineered Carbons) were used as additional fillers.

Stage 1 Formulations are shown in Table 33. Antioxidants used were 6PPD and Antioxidant DQ (Akrochem, Akron, Ohio). The rubber chemicals used were the same as those of Table 26.

TABLE 33

| Ingredients | Ex. 5_1 | Ex. 5_2 | Ex. 5_3 |
|---|---|---|---|
| Natural Rubber | 100 | 100 | 100 |
| Precipitated silica Z1165MP | 50 | 45 | 45 |
| N330 Carbon black | 5 | 4.5 | 4.5 |
| Si-69 | 5 | 4.5 | 4.5 |
| CNS wet extrudates | 0 | 0 | 2 |
| Zinc Oxide | 3 | 3 | 0 |
| Stearic Acid | 2 | 2 | 0 |
| Wax | 1.5 | 1.5 | 0 |
| 6PPD | 1.5 | 1.5 | 2 |
| Antioxidant DQ | 1.5 | 1.5 | 0 |

Protocols for stage 1 mixing shown in Table 34 (Ex. 5_1 and Ex. 5_2) and Table 35 (Ex. 5_3). Mixing conditions were: fill factor=70%; TCU temperature=80° C. (Ex. 5_1 and Ex. 5_2) or 90° C. (Ex. 5_3); rotor speed=80 rpm; ram pressure=2.8 bar. Time is cumulative time.

TABLE 34

| Time (s) | Description |
|---|---|
| 0 | Add Polymers |
| 30 | Add ⅔ Silica, carbon black, Si69 |
| 90 | Sweep/Add Remaining Filler |
| 120 | Sweep |
| 180 | Add antioxidant or antioxidant + |
| | rubber chemicals (preblended) |
| 240 | Scrape/Sweep |
| 300 | Dump - Adjust rpm not to exceed 160° C. |

TABLE 35

| | |
|---|---|
| Time or Temperature | Description |

| | | |
|---|---|---|
| 0 | s | Add Polymers |
| 30 | s | Add ¾ Silica, carbon black, Si69 |
| | | and CNS wet extrudates |

| | |
|---|---|
| 150 s or 125° C. | Sweep/Add Remaining Filler |

| | | |
|---|---|---|
| 180 | s | Sweep |
| 150° | C. | Add antioxidant and rubber chemicals |
| | | (preblended) |
| 155° | C. | Scrape/Sweep |
| 160° | C. | Dump |

The moisture content of Ex. 5_3 after stage 1 mixing was 1.0 wt. %. The resulting compounds were passed through a two-roll mill to form sheets. Formulations for stage 2 mixing are shown in Table 36 and mixing protocols are shown in Table 37. Mixing conditions were: fill factor=68%; TCU temperature=50° C.; rotor speed=80 rpm; ram pressure=2.8 bar. Time is cumulative time.

TABLE 36

| | Ex. 5_1 | Ex. 5_2 | Ex. 5_3 |
|---|---|---|---|
| Ingredients | (phr) | (phr) | (phr) |
| Stage 1 composite | 169.5 | 163.5 | 158 |
| 6PPD | 0.5 | 0.5 | 0.5 |
| Zinc Oxide | | | 3 |
| Stearic Acid | | | 2 |
| Wax | | | 1.5 |
| Antioxidant DQ | | | 1.5 |

TABLE 37

| Time or Temperature | Description |
|---|---|
| 0 s | Add stage 1 composite |
| 30 s | Add antioxidant or antioxidant + |
| | rubber chemicals (preblended) |
| 180 s or 150° C. | Dump |

The resulting stage 2 composites were passed through a two-roll mill to form sheets. In stage 3 mixing, curatives and accelerators were added in the amounts shown in Table 38 (BBTS=(N-tert-butyl-2 benzothiazole sulfenamide) was Accelerator BBTS, Akrochem, Akron, Ohio). Protocols for stage 3 mixing are shown in Table 39. Mixing conditions were: fill factor=65%, TCU temperature=50° C., rotor speed=60 rpm, ram pressure=2.8 bar. Time refers to cumulative time.

TABLE 38

| | Ex. 5_1 | Ex. 5_2 | Ex. 5_3 |
|---|---|---|---|
| Ingredients | (phr) | (phr) | (phr) |
| Stage 2 composite | 170 | 164 | 166.5 |
| Sulfur | 1.6 | 1.6 | 1.6 |
| BBTS | 2 | 2 | 2 |

TABLE 39

| Time (s) | Description |
|---|---|
| 0 | Add ½ Stage 2 composite/Curatives/ |
| | Remaining Stage 2 composite |
| 30 | Sweep |
| 90 | Dump |

Vulcanizate properties are shown in Table 40.

TABLE 40

| Properties | Ex. 5_1 | Ex. 5_2 | Ex. 5_3 |
|---|---|---|---|
| CNS loading (phr) | 0 | 0 | 2 |
| silica loading (phr) | 50 | 45 | 45 |
| Shore A hardness (RT) | 67 | 63 | 73 |
| Tensile strength (MPa) | 32.83 | 34.59 | 30.76 |
| M100 (MPa) | 3.50 | 2.97 | 7.26 |
| M300 (MPa) | 15.96 | 13.75 | 20.56 |
| Tear strength, die B (N/mm) | 166 | 158 | 153 |
| Maximum tan δ | 0.118 | 0.111 | 0.111 |
| Volume resistivity (ohm · cm) | 2.27 × 10⁹ | 2.05 × 10⁹ | 2.5 × 10² |

From the data of Table 40, it can be found that the presence of wet CNS in a silica rubber compound (Ex. 5_3) resulted in a significantly lowered volume resistivity while increasing M100, M300, and Shore A hardness values and maintaining max tan δ values.

### Example 6

This Example describes the preparation of composites where the primary filler is derived from wet or dry CNS and the secondary filler is wet or dry. Preparation and properties of the corresponding vulcanizates are also described.

CNS wet extrudates were prepared as described in Example 4. Wet silica was prepared by the following method: precipitated silica (ZEOSIL® Z1165 MP precipitated silica, Solvay USA Inc., Cranbury, N.J) and carbon black (industry reference black #9, “IRB-9”, ASTM N330) in 10 silica to 1 carbon black weight ratio were added to a FEECO Batch Pin pelletizer, and demineralized water was added to achieve a target moisture (49.2 wt. %) level. The mixture was then pelletized and moisture level of the blend was verified by gravimetric means on a moisture balance.

The natural rubber used was standard grade natural rubber RSS3 natural rubber (Hokson Rubber, Malaysia). Technical descriptions of these natural rubbers are widely available, such as in Rubber World Magazine's Blue Book published by Lippincott and Peto, Inc. (Akron, Ohio, USA).

Mixing was performed with a BR-1600 Banbury® mixer (“BR1600”; Manufacturer: Farrell) with a ram pressure of 2.8 bar. Formulations of the compounds are shown in Table 41. Mixing protocols (three stages) are outlined in Table 42 (Ex. 6_1, Ex. 6_2 and Ex. 6_3), Table 43 (Ex. 6_4, Ex. 6_5 and Ex. 6_6) and Table 44 (Ex. 6_7, Ex. 6_8, and Ex. 6_9). Mixing conditions are shown in Table 45. The silane coupling agent used was Si 69®-silane coupling agent (“Si69”; Evonik Industries). Time is cumulative time.

TABLE 41

| | | | | | | | | | |
|---|---|---|---|---|---|---|---|---|---|
| Ingredients | Ex. 6_1 | Ex. 6_2 | Ex. 6_3 | Ex. 6_4 | Ex. 6_5 | Ex. 6_6 | Ex. 6_7 | Ex. 6_8 | Ex. 6_9 |

Non-Productive Stage 1

| | | | | | | | | | |
|---|---|---|---|---|---|---|---|---|---|
| NR RSS3 | 100.0 | 100.0 | 100.0 | 100.0 | 100.0 | 100.0 | 100.0 | 100.0 | 100.0 |
| Z1165MP | 50.0 | 35.0 | 30.0 | 40.0 | 35.0 | 30.0 | | | |
| Wet Silica | | | | | | | 50.0 | 35.0 | 30.0 |
| N330 | 5.0 | 3.5 | 3.0 | 4.0 | 3.5 | 3.0 | 5.0 | 3.5 | 3.0 |
| Si69 | 5.0 | 3.5 | 3.0 | 4.0 | 3.5 | 3.0 | 5.0 | 3.5 | 3.0 |
| CNS | | 1.7 | 2.3 | | | | | 1.7 | 2.3 |
| CNS wet extrudate | | | | 1.1 | 1.7 | 2.3 | | | |
| 6PPD | 2.0 | 2.0 | 2.0 | 2.0 | 2.0 | 2.0 | 2.0 | 2.0 | 2.0 |
| ZnO | 3.0 | 3.0 | 3.0 | | | | | | |
| Stearic Acid | 2.0 | 2.0 | 2.0 | | | | | | |
| 6PPD | 0.5 | 0.5 | 0.5 | | | | | | |
| TMQ | 1.5 | 1.5 | 1.5 | | | | | | |
| Wax | 1.5 | 1.5 | 1.5 | | | | | | |

Non-Productive Stage 2

| | | | | | | | | | |
|---|---|---|---|---|---|---|---|---|---|
| 6PPD | 0.5 | 0.5 | 0.5 | 0.5 | 0.5 | 0.5 | 0.5 | 0.5 | 0.5 |
| ZnO | | | | 3.0 | 3.0 | 3.0 | 3.0 | 3.0 | 3.0 |
| Stearic Acid | | | | 2.0 | 2.0 | 2.0 | 2.0 | 2.0 | 2.0 |
| 6PPD | | | | 0.5 | 0.5 | 0.5 | 0.5 | 0.5 | 0.5 |
| TMQ | | | | 1.5 | 1.5 | 1.5 | 1.5 | 1.5 | 1.5 |
| Wax | | | | 1.5 | 1.5 | 1.5 | 1.5 | 1.5 | 1.5 |

Productive Stage 3

| | | | | | | | | | |
|---|---|---|---|---|---|---|---|---|---|
| TBBS | 2.0 | 2.0 | 2.0 | 2.0 | 2.0 | 2.0 | 2.0 | 2.0 | 2.0 |
| Sulfur | 1.6 | 1.6 | 1.6 | 1.6 | 1.6 | 1.6 | 1.6 | 1.6 | 1.6 |
| Total | 174.1 | 157.8 | 152.4 | 163.2 | 157.8 | 152.4 | 152.4 | 157.8 | 152.4 |

TABLE 42

| Time (s) | Temperature (° C.) | Description |
|---|---|---|
| 0 | 80 | Add Polymers |
| 30 | | Add ⅔ silica, N330, Si69 |
| 90 | | Sweep/Add remaining silica |
| 120 | | Sweep |
| 180 | | Add smalls (pre-blended) |
| 240 | | Scrape/Sweep |
| 300 | 160 | Dump, adjust RPM not to |
| | | exceed 160° C. |

TABLE 43

| Time (s) | Temperature (° C.) | Description |
|---|---|---|
| 0 | 90 | Add Polymers |
| 30 | | Add ¾ Silica, N330, Si69 |
| | | and CNS wet extrudates. |
| 150 | 125 | Sweep/Add Remaining Filler: |
| | | 150 sec. or 125 C. |
| 180 | | Sweep |
| | 150 | Add 6PPD |
| | 155 | Scrape/Sweep |
| | 160 | Dump |

TABLE 44

| Time (s) | Temperature (° C.) | Description |
|---|---|---|
| 0 | 90 | Add Polymers |
| 30 | | Add ¾ re-wet silica, N330, Si69 |
| | | and/or CNS dry or wet extrudates |
| 150 | 125 | Sweep/Add remaining wet silica: |
| | | 150 sec. or 125 C. |
| 180 | | Sweep |
| | 150 | Add 6PPD |
| | 155 | Scrape/Sweep |
| | 160 | Dump |

TABLE 45

| | | Ex. 6_4, Ex. 6_5, |
|---|---|---|
| | Ex. 6_1, Ex. 6_2 | Ex. 6_6, Ex. 6_7, |
| Mixing conditions | and Ex. 6_3 | Ex. 6_8, and Ex. 6_9 |
| TCU temperature (° C.) | 80 | 90 |
| Rotor speed (rpm) | 80 | 90 |
| Ram pressure (bar) | 2.8 | 2.8 |
| Fill factor | 70% | 70% |

The resulting composites were passed through a two-roll mill to form sheets. Non-productive Stage 2 mixing protocols are shown in Table 46. Mixing conditions were: fill factor=68%; TCU temperature=50° C.; rotor speed=80 rpm; ram pressure=2.8 bar. Time is cumulative time.

TABLE 46

| Time (s) | Temperature (° C.) | Description |
|---|---|---|
| 0 | 50 | Add Stage 1 composite |
| 30 | | Add Smalls(preblended) |
| 180 | 150 | Dump - Either 180 sec. or 150° C. |

The resulting stage 2 composites were passed through a two-roll mill to form sheets. Protocols for stage 3 mixing are shown in Table 47. Mixing conditions were: fill factor=65%, TCU temperature=50° C., rotor speed=60 rpm, ram pressure=2.8 bar. Time refers to cumulative time. Vulcanizate properties are shown in Table 48 as well as the moisture content (“MC”) of stage 1 composites.

TABLE 47

| Time (s) | Temperature (° C.) | Description |
|---|---|---|
| 0 | 50 | Add ½ Stage 2 composite/Curatives/ |
| | | remaining stage 2 composite |
| 30 | | Sweep |
| 90 | | Dump |

TABLE 48

| Properties | Ex. 6_1 | Ex. 6_2 | Ex. 6_3 | Ex. 6_4 | Ex. 6_5 | Ex. 6_6 | Ex. 6_7 | Ex. 6_8 | Ex. 6_9 |
|---|---|---|---|---|---|---|---|---|---|
| CNS loading | 0/0 | 1.7/1.1 | 2.3/1.5 | 1.1/0.7 | 1.7/1.1 | 2.3/1.5 | 0/0 | 1.7 | 2.3/1.5 |
| (phr/wt. %) | | | | | | | | 1.1 | |
| Silica loading | 50 | 35 | 30 | 40 | 35 | 30 | 50 | 35 | 30 |
| (phr) | | | | | | | | | |
| MC of stage 1 | 1.3 | N/A | N/A | 1.1 | 0.7 | 0.7 | 1.1 | 0.7 | 0.6 |
| composite | | | | | | | | | |
| Shore A | 66 | 67 | 69 | 64 | 62 | 65 | 64 | 63 | 61 |
| hardness (RT) | | | | | | | | | |
| Tensile | 32.6 | 31.9 | 28.7 | 31.7 | 29.2 | 26.4 | 32.5 | 28.1 | 26.3 |
| strength | | | | | | | | | |
| (MPa) | | | | | | | | | |
| M100 (MPa) | 3 | 5.2 | 5.2 | 4.0 | 4.5 | 4.9 | 3.4 | 4.1 | 4.9 |
| M300 (MPa) | 13.8 | 16.1 | 15.6 | 15.9 | 16.7 | 17.5 | 17.3 | 15.7 | 16.6 |
| Maximum tan | 0.13 | 0.08 | 0.072 | 0.072 | 0.051 | 0.050 | 0.095 | 0.049 | 0.042 |
| δ(60° C.) | | | | | | | | | |
| Volume | 5.1 × 10⁹ | 1.4 × 10⁴ | 7.8 × 10³ | 2.9 × 10⁹ | 1.5 × 10⁶ | 1 × 10⁶ | 2.7 × 10⁹ | 2.3 × 10⁹ | 2.7 × 10⁹ |
| resistivity | | | | | | | | | |
| (Ohm · cm) | | | | | | | | | |

The compounds of Ex. 6_2, Ex. 6_3, which contains CNS at 1.7 phr and 2.3 phr respectively, and also contain dry silica at 35 phr and 30 phr, respectively, show significantly lower volume resistivity and lower maximum tan δ values compared to the compound of Ex. 6_1 having 50 phr dry silica and no CNS. Despite the lower filler loadings, Ex. 6_2, Ex. 6_3 compounds maintain a similar shore A hardness. The compounds of Ex. 6_5 and Ex. 6_6, which were formed from wet CNS (wet extrudates) displayed an even further decrease in maximum tan δ while still achieving low volume resistivity.

The compounds of Ex. 6_7, Ex. 6_8, and Ex. 6_9, were prepared from wet silica. The incorporation of dry CNS pellets combined with a low loading of wet silica (Ex. 6_8, and Ex. 6_9) led to compounds with low maximum tan δ while maintaining the shore A hardness properties.

### Example 7

This Example describes the preparation of composites containing silica and CNS and the corresponding vulcanizates using dry silica, wet silica, dry CNS and CNS wet extrudates.

Formulations are shown in Table 49 (all amounts provided are in phr unless stated otherwise). CNS wet extrudates were prepared as described in Example 4. Wet silica and carbon black was prepared as described in Example 6.

TABLE 49

| | | | | | | | | | |
|---|---|---|---|---|---|---|---|---|---|
| Ingredients | Ex. 7_1 | Ex. 7_2 | Ex. 7_3 | Ex. 7_4 | Ex. 7_5 | Ex. 7_6 | Ex. 7_7 | Ex. 7_8 | Ex. 7_9 |

Non-Productive Stage 1

| | | | | | | | | | |
|---|---|---|---|---|---|---|---|---|---|
| RSS3 | 100.0 | 100.0 | 100.0 | 100.0 | 100.0 | 100.0 | 100.0 | 100.0 | 100.0 |
| Z1165MP | 50.0 | 40.0 | 45.0 | 40.0 | | | | | |
| Wet Silica | | | | | 50.0 | 45.0 | 40.0 | 45.0 | 40.0 |
| N330 | 5.0 | 4.0 | 4.5 | 4.0 | 5.0 | 4.5 | 4.0 | 4.5 | 4.0 |
| Si69 | 5.0 | 4.0 | 4.5 | 4.0 | 5.0 | 4.5 | 4.0 | 4.5 | 4.0 |
| CNS | | | | | | 1.5 | 1.7 | | |
| CNS Wet Extrudates | | | 1.5 | 1.7 | | | | 1.5 | 1.7 |
| 6PPD | 2.0 | 2.0 | 2.0 | 2.0 | 2.0 | 2.0 | 2.0 | 2.0 | 2.0 |
| ZnO | 3.0 | 3.0 | | | | | | | |
| Stearic Acid | 2.0 | 2.0 | | | | | | | |
| TMQ. | 1.5 | 1.5 | | | | | | | |
| Wax | 1.5 | 1.5 | | | | | | | |

Non-Productive Stage 2

| | | | | | | | | | |
|---|---|---|---|---|---|---|---|---|---|
| 6PPD | 0.5 | 0.5 | 0.5 | 0.5 | 0.5 | 0.5 | 0.5 | 0.5 | 0.5 |
| ZnO | | | 3.0 | 3.0 | 3.0 | 3.0 | 3.0 | 3.0 | 3.0 |
| Stearic Acid | | | 2.0 | 2.0 | 2.0 | 2.0 | 2.0 | 2.0 | 2.0 |
| 6PPD | | | 0.5 | 0.5 | 0.5 | 0.5 | 0.5 | 0.5 | 0.5 |
| TMQ | | | 1.5 | 1.5 | 1.5 | 1.5 | 1.5 | 1.5 | 1.5 |
| Wax | | | 1.5 | 1.5 | 1.5 | 1.5 | 1.5 | 1.5 | 1.5 |

Productive Stage 3

| | | | | | | | | | |
|---|---|---|---|---|---|---|---|---|---|
| TBBS | 2.0 | 2.0 | 2.0 | 2.0 | 2.0 | 2.0 | 2.0 | 2.0 | 2.0 |
| Sulfur | 1.6 | 1.6 | 1.6 | 1.6 | 1.6 | 1.6 | 1.6 | 1.6 | 1.6 |
| Total | 174.1 | 162.1 | 169.6 | 163.8 | 174.1 | 169.6 | 163.8 | 169.6 | 163.8 |
| CNS Concentration, | 0.0 | 0.0 | 0.9 | 1.0 | 0.0 | 0.9 | 1.0 | 0.9 | 1.0 |
| wt. % | | | | | | | | | |

Ex. 71 is the same as Ex. 6_1 of Example 6. Example 7_5 is the same as Example 67 of Example 6.

Ex. 72 was mixed following the mixing protocols as outlined in Table 42 (Non-productive Stage 1), Table 46 (Non-productive Stage 2) and Table 47 (Productive Stage 3) of Example 6. Ex. 7_3 through Ex. 7_9 were mixed following the mixing protocols as outlined in Table 43 (Ex. 7_3 and Ex. 7_4) or Table 44 (Ex. 7_5 through Ex. 7_9) (Non-productive Stage 1), Table 46 (Non-productive Stage 2) and Table 47 (Productive Stage 3). A rotor speed of 95 was used in non-productive stage 1 for mixing Ex. 7_3, Ex. 7_4, Ex. 7_6, Ex. 7_8 and Ex. 7_9, except for Ex. 7_5 where 90 rpm was used. Properties of the resulting vulcanizates are shown in Table 50 as well as moisture content (“MU”) of the stage 1 composites.

TABLE 50

| Properties | Ex. 7_1 | Ex. 7_2 | Ex. 7_3 | Ex. 7_4 | Ex. 7_5 | Ex. 7_6 | Ex. 7_7 | Ex. 7_8 | Ex. 7_9 |
|---|---|---|---|---|---|---|---|---|---|
| RSS3 | 100.0 | 100.0 | 100.0 | 100.0 | 100.0 | 100.0 | 100.0 | 100.0 | 100.0 |
| silica (Z1165MP) | 50.0 | 40.0 | 45.0 | 40.0 | | | | | |
| wet silica | | | | | 50.0 | 45.0 | 40.0 | 45.0 | 40.0 |
| CB N330 | 5.0 | 4.0 | 4.5 | 4.0 | 5.0 | 4.5 | 4.0 | 4.5 | 4.0 |
| Si69 | 5.0 | 4.0 | 4.5 | 4.0 | 5.0 | 4.5 | 4.0 | 4.5 | 4.0 |
| CNS | | | | | | 1.5 | 1.7 | | |
| CNS Wet Extrudate | | | 1.5 | 1.7 | | | | 1.5 | 1.7 |
| MC of stage 1 | N/A | N/A | 0.7 | 0.8 | 1.1 | 1.2 | 0.7 | 1.3 | 1.7 |
| composite | | | | | | | | | |
| 100% Modulus, MPa | 3.0 | 2.5 | 4.7 | 5.4 | 3.4 | 4.8 | 4.3 | 6.0 | 7.2 |
| 300% Modulus, MPa | 13.8 | 12.2 | 16.1 | 17.6 | 17.3 | 17.4 | 16.4 | 19.5 | 20.0 |
| Tensile Strength, MPa | 32.6 | 34.3 | 31.2 | 31.2 | 32.5 | 30.5 | 30.8 | 31.2 | 32.7 |
| Elongation at Break, % | 590 | 604 | 518 | 497 | 501 | 484 | 498 | 475 | 488 |
| Shore A Hardness at | 66 | 59 | 65 | 67 | 64 | 65 | 63 | 70 | 70 |
| 23° C. | | | | | | | | | |
| Volume resistivity, | 5.1 × 10⁹ | 4.5 × 10⁹ | 7.7 × 10⁵ | 4.7 × 10⁴ | 2.7 × 10⁹ | 2.4 × 10⁸ | 7.9 × 10⁸ | 6.9 × 10⁴ | 2.4 × 10⁴ |
| Ohm · cm | | | | | | | | | |
| Maximum tan δ (60° C.) | 0.130 | 0.084 | 0.115 | 0.088 | 0.095 | 0.078 | 0.064 | 0.122 | 0.119 |

The CNS-containing formulations in Example 7 contained higher loading levels of silica (40 and 45 phr) (compared to the formulations of Example 6) and CNS wt. % levels of 0.9 to 1.0 wt. % to achieve good electrical conductivity of the rubber composition.

It can be seen in Table 50 that with the exception of Ex. 7_2, all compounds exhibited a hardness value close to that of Ex. 7_1, which contained a higher silica loading level of 50 phr (66 Shore A). Ex. 7_3 and Ex. 7_4, prepared from the mixing of dry silica and wet CNS, exhibited significantly increased 100% and 300% modulus and much reduced hysteresis loss tan delta while decreasing the volume resistivity to <1×10⁶ Ohm·cm (i.e. increased electrical conductivity, desirable for certain applications), of the rubber compound. Ex. 7_5, prepared from the mixing of wet silica, exhibited significantly increased 100% and 300% modulus and much reduced hysteresis loss tan delta. The inclusion of dry CNS with wet silica (Ex. 7_6 and Ex. 7_7) led to further reduced hysteresis loss tan delta. Ex. 7_8 and Ex. 7_9, prepared from the mixing of wet silica and wet CNS, exhibited even more significantly increased 100% and 300% modulus and reduced hysteresis loss tan delta while increasing the electrical conductivity (volume resistivity <1×10⁵ Ohm·cm) of the rubber compound.

These formulations or similar formulations as shown in the examples can be incorporated in tires and can potentially lead to one of reduced rolling resistance, heat buildup, and/or potentially improved treadwear performance without the hazard associated with the electrical charge in the vehicle.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While this invention has been particularly shown and described with references to preferred embodiments thereof, it will be understood by those skilled in the art that various changes in form and details may be made therein without departing from the scope of the invention encompassed by the appended claims.

1. An elastomeric composition comprising:
at least one elastomer; and
at least one primary filler that is carbon nanostructures, fragments of carbon nanostructures, or fractured multiwall carbon nanotubes, or any combinations thereof; and optionally at least one secondary filler;
wherein the at least one primary filler is present in an amount of from 0.1 phr to about 50 phr, and wherein the carbon nanostructures or fragments of carbon nanostructures include a plurality of multiwall carbon nanotubes that are crosslinked in a polymeric structure by being branched, interdigitated, entangled and/or sharing common walls, and
wherein the fractured multiwall carbon nanotubes are derived from carbon nanostructures and are branched and share common walls with one another.

2. The elastomeric composition of claim 1, wherein
at least one of the multiwall carbon nanotubes has a length equal to or greater than 2 microns, as determined by SEM,
at least one of the multiwall carbon nanotubes has a length to diameter aspect ratio within a range of from 10 to 1000,
there are at least two branches along a 2-micrometer length of at least one of the multiwall carbon nanotube, as determined by SEM,
at least one multiwall carbon nanotube exhibits an asymmetry in the number of walls observed in the area after a branching point relative to the area prior to the branching point, and/or
no catalyst particle is present at or near branching points, as determined by TEM.

3. The elastomeric composition of claim 1, wherein the multiwall nanotubes include 2 to 30 coaxial nanotubes, as determined by TEM at a magnification sufficient for counting the number of walls.

4. The elastomeric composition of claim 1, wherein at least 1% of the carbon nanotubes have a length equal to or greater than 2 microns, as determined by SEM, a length to diameter aspect ratio within a range of from 10 to 1000, and/or exhibit an asymmetry in the number of walls observed in the area after a branching point relative to the area prior to the branching point.

5. The elastomeric composition of claim 1, wherein said at least one primary filler is uniformly distributed in said at least one elastomer.

6. The elastomeric composition of claim 1, wherein said amount of said at least one primary filler is from 0.1 phr to 5 phr.

7. (canceled)

8. The elastomeric composition of claim 14, wherein said amount of said at least one secondary filler is at least 20 phr.

9-11. (canceled)

12. The elastomeric composition of claim 1, wherein said at least one elastomer is natural rubber, functionalized natural rubber, solution styrene butadiene rubber (sSBR), emulsion styrene butadiene rubber (ESBR), functionalized styrene-butadiene rubber, polybutadiene rubber (BR), functionalized polybutadiene rubber, butyl rubber, chlorinated butyl rubber (CIIR), brominated butyl rubber (BIIR), polychloroprene rubber, acrylonitrile butadiene rubber (NBR), hydrogenated acrylonitrile butadiene rubber (HNBR), fluoroelastomer (FKM), or perfluoroelastomers (FFKM), TFE/P rubber, ethylene propylene diene monomer rubber (EPDM), ethylene/acrylic elastomers (AEM), polyacrylates (ACM), polyisoprene, ethylene-propylene rubber, or any combinations thereof.

13. The elastomeric composition of claim 1, wherein said at least one primary filler is the sole filler present in said elastomeric composition.

14. The elastomeric composition of claim 1, wherein said at least one secondary filler is present.

15. The elastomeric composition of claim 14, wherein said at least one secondary filler is carbon black, silica, clay, mica, kaolin, calcium carbonate, carbon nanotubes, pyrolysis carbon, reclaimed carbon, recovered carbon black, nanocellulose, graphene, carbon fiber, KEVLAR fiber, glass fiber, glass sphere, nylon fiber, graphite, boron nitride, graphite nanoplatelet, reduced graphene oxide, combinations thereof, or coated and treated materials thereof.

16. The elastomeric composition of claim 14, wherein said at least one secondary filler is carbon black, silica, and silicon-treated carbon black, or combinations thereof.

17. The elastomeric composition of claim 1, wherein said at least one primary filler contributes to at least 50% of at least one mechanical property attribute achieved by the presence of fillers.

18-19. (canceled)

20. The elastomeric composition of claim 17, wherein said at least one mechanical property attribute is selected from at least one of M50, tensile strength, and tear strength.

21-22. (canceled)

23. The elastomeric composition of claim 1, wherein said at least one primary filler is capable of providing a volume resistivity of 10⁷ ohm·cm or less at a loading of 2 phr, to the elastomeric composition.

24. The elastomeric composition of claim 1, wherein said at least one primary filler is capable of providing a volume resistivity of 10⁷ ohm·cm or less at a loading of 2 wt. %, to the elastomeric composition.

25. The elastomeric composition of claim 1, wherein said at least one primary filler has an impact number of 2 or higher, wherein said impact number is:
Impact Number=(total filler phr/primary filler phr)×(primary filler mechanical property contribution),
wherein the primary filler mechanical property contribution is:
Primary filler mechanical property contribution=(mechanical property A with only x phr primary filler)/(mechanical property A with x phr primary filler+y phr secondary filler).

26. The elastomeric composition of claim 25, wherein said filler property is based on measuring at least one of tensile strength, tear strength, M50, and M100.

27-28. (canceled)

29. The elastomeric composition of claim 1, wherein the carbon nanostructures are coated carbon nanostructures.

30. The elastomeric composition of claim 29, wherein the coated carbon nanostructures are polyurethane-coated nanostructures or polyethylene glycol-coated carbon nanostructures or latex-coated carbon nanostructures.

31. The elastomeric composition of claim 29, wherein the weight of the coating relative to the weight of the coated carbon nanostructures is within the range of from about 0.1% to about 10%.

32. The elastomeric composition of claim 1, where a volume resistivity is lower than 10⁶ ohm·cm and the Mooney viscosity of the elastomeric composition is lower than 1.2 times the Mooney viscosity of the neat rubber under the same testing condition.

33. An article of manufacture comprising the elastomeric composition of claim 1.

34. The article of claim 33, wherein said article is a tire or a component thereof.

35. The article of claim 33, wherein said article is a tire tread or tire sidewall.

36. The article of claim 33, wherein said article is a O-ring seals, O-ring sealants, gaskets, diaphragms, valves, hydraulic seals, swell packers, blow out preventers, oil resistant hose liners, wire harnesses, battery cables, turbo hoses, molded air ducts, brake parts, grommets, hydraulic and radiator hoses, transmission seals, transmission gaskets, engine or chassis vibration mounts, constant velocity joint boots, engine seals, or fuel system components.

37. A method for preparing the elastomeric composition of claim 1, said method comprising combining at least one elastomer and at least one primary filler and optionally at least one secondary filler to form said elastomeric composition,
wherein said at least one primary filler is carbon nanostructures, fragments of carbon nanostructures, or fractured multiwall carbon nanotubes, or any combinations thereof, and
wherein the at least one primary filler is present in an amount of from 0.1 phr to about 50 phr, and wherein the carbon nanostructures or fragments of carbon nanostructures include a plurality of multiwall carbon nanotubes that are crosslinked in a polymeric structure by being branched, interdigitated, entangled and/or sharing common walls, and
wherein the fractured multiwall carbon nanotubes are derived from carbon nanostructures and are branched and share common walls with one another.

38. The method of claim 37, wherein said combining comprises forming a masterbatch by combining the at least one elastomer and the at least one primary filler, and combining the masterbatch with or without at least one secondary filler.

39-41. (canceled)

42. The method of claim 37, wherein the elastomer is a solid elastomer and at least one of the primary and secondary fillers is a wet filler comprising a liquid present in an amount of at least 15% by weight based on total weight of wet filler, and said combining comprises: (a) charging a mixer with the solid elastomer and the wet filler; (b) in one or more mixing steps, mixing the at least the solid elastomer and the wet filler to form a mixture, and removing at least a portion of the liquid from the mixture by evaporation; and (c) discharging, from the mixer, the composite comprising the primary filler dispersed in the elastomer, wherein the composite has a liquid content of no more than 20% by weight based on total weight of said composite.

43. The method of claim 37, wherein said at least one elastomer has been subjected to one or more of the following steps: one or more dewatering steps, one or more mixing steps, and/or one or more compounding steps to obtain a processed elastomer, and then combining at least one primary filler and optionally at least one secondary filler to the processed elastomer to form said elastomeric composition,
wherein said at least one primary filler is carbon nanostructures, fragments of carbon nanostructures, or fractured multiwall carbon nanotubes, or any combinations thereof, and
wherein the at least one primary filler is present in an amount of from 0.1 phr to about 50 phr, and wherein the carbon nanostructures or fragments of carbon nanostructures include a plurality of multiwall carbon nanotubes that are crosslinked in a polymeric structure by being branched, interdigitated, entangled and/or sharing common walls, and
wherein the fractured multiwall carbon nanotubes are derived from carbon nanostructures and are branched and share common walls with one another.

44. A method of preparing a composite, comprising:
(a) charging a mixer with at least a solid elastomer and a wet filler comprising at least one primary filler and a liquid present in an amount of at least 50% by weight based on total weight of wet filler;
(b) in one or more mixing steps, mixing the at least the solid elastomer and the wet filler to form a mixture, and removing at least a portion of the liquid from the mixture by evaporation; and
(c) discharging, from the mixer, the composite comprising the at least one primary filler dispersed in the elastomer, wherein the composite has a liquid content of no more than 20% by weight based on total weight of said composite,
wherein the at least one primary filler is selected from carbon nanostructures, fragments of carbon nanostructures, fractured multiwall carbon nanotubes, and combinations thereof, wherein the carbon nanostructures or fragments of carbon nanostructures include a plurality of multiwall carbon nanotubes that are crosslinked in a polymeric structure by being branched, interdigitated, entangled and/or sharing common walls, and wherein the fractured multiwall carbon nanotubes are derived from the carbon nanostructures and are branched and share common walls with one another.

45-48. (canceled)

49. The method of claim 44, wherein the wet filler is a first wet filler, and the charging (a) comprises charging a second wet filler comprising the at least one secondary filler and a liquid present in an amount of at least 15% by weight based on total weight of the second wet filler.

50-61. (canceled)

62. A method of preparing a composite, comprising:
(a) charging a mixer with at least a solid elastomer, at least one primary filler, and a wet filler comprising at least one secondary filler and a liquid present in an amount of at least 15% by weight based on total weight of wet filler;
(b) in one or more mixing steps, mixing the at least the solid elastomer and the wet filler to form a mixture, and removing at least a portion of the liquid from the mixture by evaporation; and
(c) discharging, from the mixer, the composite comprising the at least one primary and secondary filler dispersed in the elastomer, wherein the composite has a liquid content of no more than 10% by weight based on total weight of said composite,
wherein the at least one primary filler is selected from carbon nanostructures, fragments of carbon nanostructures, fractured multiwall carbon nanotubes, and combinations thereof, wherein the carbon nanostructures or fragments of carbon nanostructures include a plurality of multiwall carbon nanotubes that are crosslinked in a polymeric structure by being branched, interdigitated, entangled and/or sharing common walls, and wherein the fractured multiwall carbon nanotubes are derived from the carbon nanostructures and are branched and share common walls with one another.

63-64. (canceled)
